(19) United States
(12) Patent Application Publication
(10) Pub. No.: US 2011/0304657 A1
(43) Pub. Date: Dec. 15, 2011

(54) BACKLIGHT DEVICE AND DISPLAY DEVICE

(75) Inventors: Akihiro Yamamura, Osaka (JP); Takahiro Kobayashi, Osaka (JP); Yoshio Umeda, Hyogo (JP); Hideyuki Nakanishi, Osaka (JP); Toshiki Onishi, Osaka (JP); Seiji Hamada, Osaka (JP)

(73) Assignee: PANASONIC CORPORATION, Kadoma-shi, Osaka (JP)

(21) Appl. No.: 13/203,181

(22) PCT Filed: Sep. 28, 2010
(86) PCT No.: PCT/JP2010/005816

§ 371 Date: Aug. 24, 2011

(30) Foreign Application Priority Data
Sep. 30, 2009 (JP) 2009-228472

(51) Int. Cl. G09G 5/10

(52) U.S. Cl. 345/690

(57) ABSTRACT

Disclosed is a backlight device that reduces elevated black levels and the visibility of flickering when displaying a video. A light-emitting unit (121) is provided with a plurality of light-emitting areas that individually emit illumination light, and illuminates a liquid crystal panel (110) with the illumination light from the plurality of light-emitting areas. A motion detection unit (150) detects image motion from an image signal. A brightness control unit (130) acquires a brightness determination reference value for each light-emitting area on the basis of the image signal, and in regards to each of the plurality of light-emitting areas, weights the acquired brightness determination reference value for each of the one or more light-emitting areas that constitute a weighting region and determines the light emission brightness value for each of the light-emitting areas on the basis of the weighting results. An LED driver (122) drives each of the plurality of light-emitting areas in accordance with the determined light emission brightness value for each of the light-emitting areas. The brightness control unit (130) dynamically sets the light-emitting areas that constitute the weighting areas in accordance with the detected motion.

### TECHNICAL FIELD

The present invention relates to a backlight apparatus and a display apparatus using this backlight apparatus. More particularly, the present invention relates to a backlight apparatus and display apparatus for individually controlling lighting of a plurality of display areas.

### BACKGROUND ART

A non-self-luminous display apparatus, typified by a liquid crystal display apparatus, has a backlight apparatus (or hereinafter simply referred to as “backlight”) in the back. A display apparatus of this kind displays an image through an optical modulation section, such as a liquid crystal panel. The optical modulation section adjusts the reflectance or transmittance of light emitted from the backlight in accordance with image signals. Also, in order to expand the dynamic range of display brightness, a display apparatus of this kind employs a configuration in which the illuminating section of the backlight is divided into a plurality of areas and brightness is controlled on a per area basis.

With the configuration described above, from the perspective of cost, it is difficult to make the number of divisions of the backlight (i.e. backlight resolution) the same as the resolution of the optical modulation section. Accordingly, the resolution of a backlight is usually lower than the resolution of an optical modulation section. Therefore, problems occur due to the difference in resolution between the backlight and the optical modulation section. One of the problems is the phenomenon where a part that is supposed be displayed in black becomes bright and appears distinct (hereinafter “impure black”). This problem will be explained below using FIG. 1 and FIG. 2.

FIG. 1A to FIG. 1C illustrate the state of “impure black” in a still image.

FIG. 1A shows input image A1 (or the state in which modulation is performed in the optical modulation section). In input image A1, there is a circular object with high peak brightness on a black background. Note that the broken lines on input image A1 in this drawing are shown to help understand the position of a partial image corresponding to the position of a light emitting area, and are not objects that really exist in input image A1. The same applies to other drawings showing an input image.

FIG. 1B shows the light emitting state of backlight B1. Here, backlight B1 has nine light emitting areas arranged in a matrix shape. Note that the solid lines on backlight B1 in the drawing are shown to help understand the positions of light emitting areas, and do not necessarily mean that backlight B1 is structurally divided. The same applies to other drawings to show the configuration and light emission state of backlight.

The partial image corresponding to the light emitting area situated in the center of the nine light emitting areas includes a circular object having high peak brightness, so that this center light emitting area emits light according to the brightness of that partial image. Then, the light emitting areas that are located around that center light emitting area all correspond to black partial images and are therefore turned off.

FIG. 1C shows display image C1 that is displayed by means of an optical modulation section. Here, the optical modulation section has nine image display areas placed in a matrix shape in accordance with the above light emitting areas. The broken lines on display image C1 are shown to help understand the positions of light emitting areas corresponding to the positions of light emitting areas, and are not objects to be actually displayed on display image C1. The same applies to other drawings to show the configuration of the optical modulation section and display image.

In this way, even in a black part in the image display area located in the center of nine image display areas, a small amount of light passes. Therefore, a difference in brightness of the black color of the background is produced between the center image display area and neighboring areas around this center area. As a result, “impure black” is produced distinctly in the center area compared to the neighboring areas.

FIG. 2A, FIG. 2B and FIG. 2C illustrate “impure black” in movie.

FIG. 2A shows how the circular object in FIG. A2 moves from the left to the right.

FIG. 2B shows how the light emission state of backlight B2 transitions. When the circular object moves to the right across two light emitting areas, both light emitting areas emit light. Consequently, compared to the time the circular object is include in a single light emitting area, the total area of light emitting areas (that is, the area of light emission) becomes large. Likewise, if the circular object moves further to the right, the circle is once again included in a single light emitting area, and the light emitting area and the area of light emission becomes smaller.

FIG. 2C shows how display image C2 displayed on the display apparatus transitions. When an object having a different brightness from the surroundings moves, the area of the part where “impure black” (that is, the impure black area) is produced, changes at the timing the object crosses over light emitting areas. When the area of light emitting areas changes in this way, impure black becomes more visible as a flicker-like phenomenon.

As a method of reducing impure black, for example, patent literature 1 discloses controlling movie parameters such as backlight brightness such that backlight brightness changes following a predetermined slope, with respect to areas where display brightness changes sharply.

### CITATION LIST

### Patent Literature

### PTL 1

Japanese Patent Application Laid-Open No. 2008-51905

### SUMMARY OF INVENTION

### Technical Problem

However, with the liquid crystal display apparatus disclosed in patent literature 1, for example, as shown in FIG. 1B, whether or not to correct the brightness of nearby light emitting areas is determined using a threshold value for brightness difference. If, upon movie display, the relationship between the difference in brightness between the center light emitting area and its surrounding light emitting areas and a threshold is reversed, then a discontinuity of brightness in time is produced in the surrounding light emitting areas. Such discontinuity of brightness may be recognized as a flicker-like phenomenon by the observer.

It is therefore an object of the present invention to provide a backlight apparatus and display apparatus that can reduce impure black upon movie display and also reduce the visibility of flicker.

### Solution to Problem

A backlight apparatus of the present invention has: a light emitting section that has a plurality of light emitting areas which emit illumination light individually, and that illuminates an optical modulation section by the illumination light from the plurality of light emitting areas; a motion detecting section that detects motion of an image from an image signal; a brightness control section that acquires a brightness determination reference value for each light emitting area based on the image signal, applies weights to brightness determination reference values acquired with respect to one or more light emitting areas constituting the weighting area, and determines light emission brightness values on a per light emitting area basis based on results of the weighting; and a drive section that drives each of the plurality of light emitting areas according to the light emission brightness values determined on a per light emitting area basis, and, in this back light apparatus, the brightness control section sets the light emitting areas to constitute the weighting area in accordance with detected motion.

A display apparatus according to the present invention has the above backlight apparatus and the above optical modulation section.

### ADVANTAGEOUS EFFECTS OF INVENTION

According to the present invention, it is possible to reduce impure black upon movie display and also reduce the visibility of flicker.

### BRIEF DESCRIPTION OF DRAWINGS

FIG. 1A shows how an input image looks when typical “impure black” is produced in a still image;

FIG. 1B shows how a backlight looks when typical “impure black” is produced in a still image;

FIG. 1C shows how a display image looks when typical “impure black” is produced in a still image;

FIG. 2A shows how an input image looks when typical “impure black” is produced in movie;

FIG. 2B shows how a backlight looks when typical “impure black” is produced in movie;

FIG. 2C shows how a display image looks when typical “impure black” is produced in movie;

FIG. 3 is a block diagram showing a configuration of a liquid crystal display apparatus according to embodiment 1 of the present invention;

FIG. 4 shows a configuration of a light emitting section according to embodiment 1;

FIG. 5 shows an example of a motion detection result according to embodiment 1;

FIG. 6 shows another example of a motion detection result according to embodiment 1;

FIG. 7 is a block diagram showing a configuration of a liquid crystal display apparatus according to embodiment 1;

FIG. 8A shows a first example of a conversion table for conversion from feature amount to reference brightness value according to embodiment 1;

FIG. 8B shows a second example of a conversion table for conversion from feature amount to reference brightness value according to embodiment 1;

FIG. 8C shows a third example of a conversion table for conversion from feature amount to reference brightness value;

FIG. 9 is a block diagram showing a configuration of a weighting section according to embodiment 1;

FIG. 10A shows a first example of a weight control result for explaining the weight control method according to embodiment 1;

FIG. 10B shows a second example of a weight control result for explaining the weight control method according to embodiment 1;

FIG. 10C shows a third example of a weight control result for explaining the weight control method according to embodiment 1;

FIG. 10D shows a fourth example of a weight control result for explaining the weight control method according to embodiment 1;

FIG. 10E shows a fifth example of a weight control result for explaining the weight control method according to embodiment 1;

FIG. 10F shows a sixth example of a weight control result for explaining the weight control method according to embodiment 1;

FIG. 10G shows a seventh example of a weight control result for explaining the weight control method according to embodiment 1;

FIG. 10H shows an eighth example of a weight control result for explaining the weight control method according to embodiment 1;

FIG. 11 shows an example of an image to be input in a liquid crystal panel according to embodiment 1;

FIG. 12 shows the reference brightness values of light emitting areas, calculated according to embodiment 1;

FIG. 13 shows a state of light emission without a weighting section;

FIG. 14 shows an image to be actually displayed on a liquid crystal panel in the case of FIG. 13;

FIG. 15 shows weighted brightness values acquired according to embodiment 1;

FIG. 16 illustrates calculation of weighted brightness values according to embodiment 1;

FIG. 17 shows a state of light emission when a weighting section is provided;

FIG. 18 shows an image to be actually displayed on a liquid crystal panel in the case of FIG. 17;

FIG. 19A shows operation of a liquid crystal display apparatus when the motion of a detected image shows medium speed, according to embodiment 1;

FIG. 19B shows operation of a liquid crystal display apparatus when the motion of a detected image shows high speed, according to embodiment 1;

FIG. 19C shows operation of a liquid crystal display apparatus when a detected image shows no motion, according to embodiment 1;

FIG. 20A shows a first example of a weighting area setting method according to embodiment 1;

FIG. 20B shows a second example of a weighting area setting method according to embodiment 1;

FIG. 20C shows a third example of a weighting area setting method according to embodiment 1;

FIG. 20D shows a fourth example of a weighting area setting method according to embodiment 1;

FIG. 20E shows a fifth example of a weighting area setting method according to embodiment 1;

FIG. 20F shows a sixth example of a weighting area setting method according to embodiment 1;

FIG. 20G shows a seventh example of a weighting area setting method according to embodiment 1;

FIG. 20H shows an eighth example of a weighting area setting method according to embodiment 1;

FIG. 20I shows a ninth example of a weighting area setting method according to embodiment 1;

FIG. 21 is a block diagram showing a variation of a configuration of a brightness control section according to embodiment 1;

FIG. 22 is a block diagram showing a variation of a configuration of a weighting section according to embodiment 1;

FIG. 23A shows a first example of a conversion table for conversion from weighted feature amount to reference brightness value according to a variation of embodiment 1;

FIG. 23B shows a second example of a conversion table for conversion from weighted feature amount to reference brightness value according to a variation of embodiment 1;

FIG. 23C shows a third example of a conversion table for conversion from weighted feature amount to reference brightness value according to a variation of embodiment 1;

FIG. 24 is a block diagram showing a configuration of a liquid crystal display apparatus according to embodiment 2 of the present invention;

FIG. 25 shows a first example of a motion detection result according to embodiment 2;

FIG. 26 shows a second example of a motion detection result according to embodiment 2;

FIG. 27 shows a third example of a motion detection result according to embodiment 2;

FIG. 28 is a block diagram showing a brightness control section according to embodiment 2;

FIG. 29 is a block diagram showing a brightness control section according to embodiment 2;

FIG. 30A shows a first example of a weighting area setting method according to embodiment 2;

FIG. 30B shows a second example of a weighting area setting method according to embodiment 2;

FIG. 30C shows a third example of a weighting area setting method according to embodiment 2;

FIG. 30D shows a fourth example of a weighting area setting method according to embodiment 2;

FIG. 31 is a block diagram showing a configuration of a liquid crystal display apparatus according to embodiment 3 of the present invention;

FIG. 32 shows a first example of motion detection result according to embodiment 3;

FIG. 33 is a block diagram showing a configuration of a brightness control section according to embodiment 3;

FIG. 34 is a block diagram showing a configuration of a weighting section according to embodiment 3;

FIG. 35A shows a first example of a weighting area setting method according to embodiment 3;

FIG. 35B shows a first example of a weighting area setting method according to embodiment 3;

FIG. 35C shows a first example of a weighting area setting method according to embodiment 3;

FIG. 35D shows a first example of a weighting area setting method according to embodiment 3; and

FIG. 36 shows a second example of motion detection result according to embodiment 3;

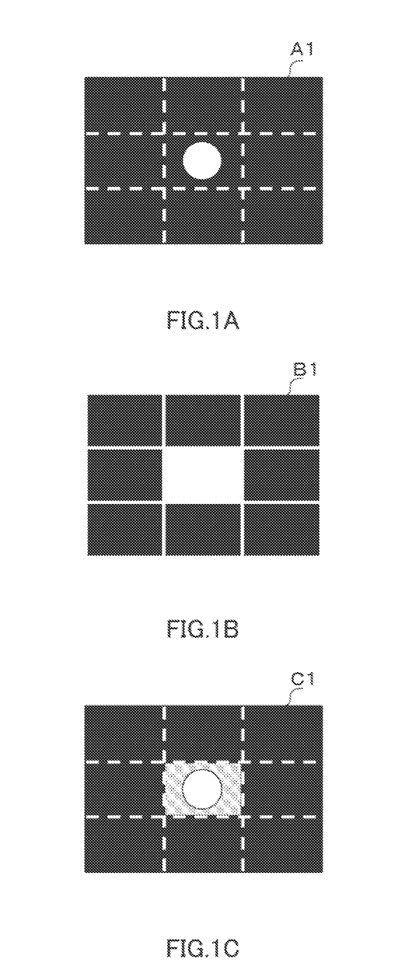

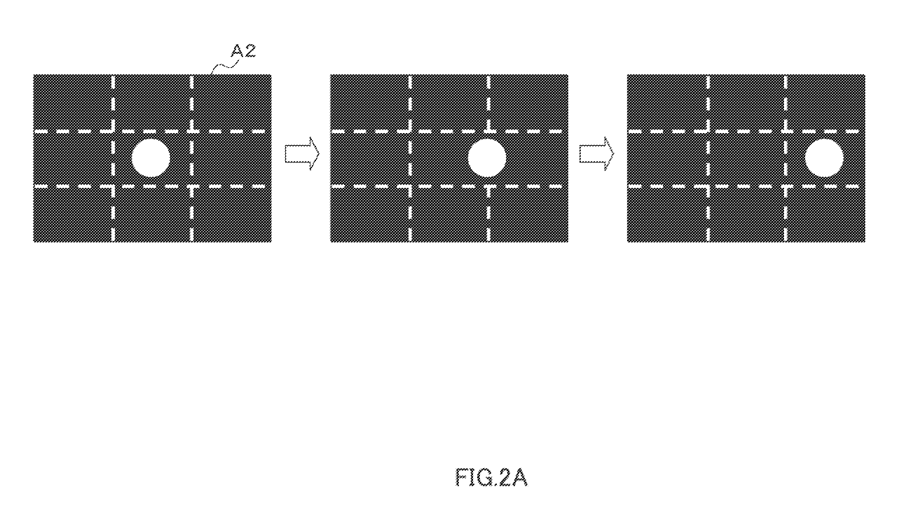

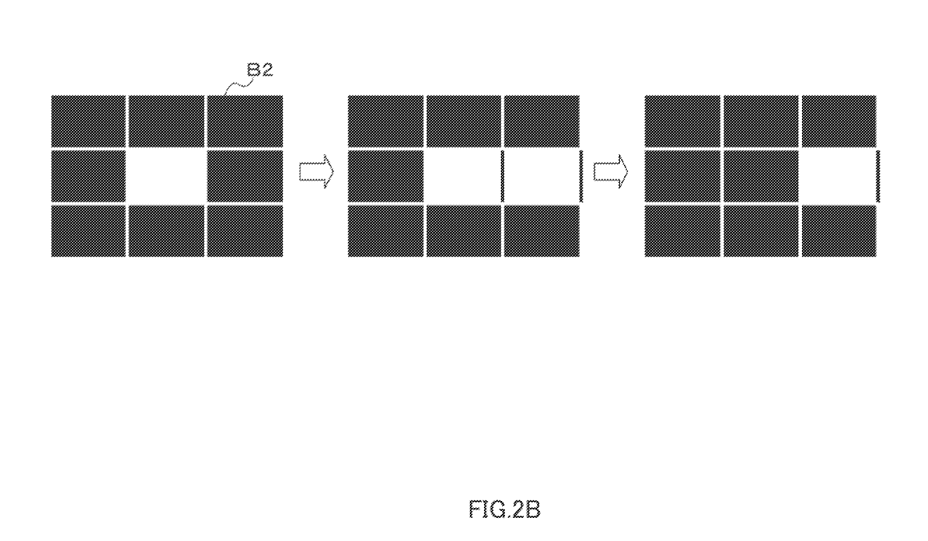

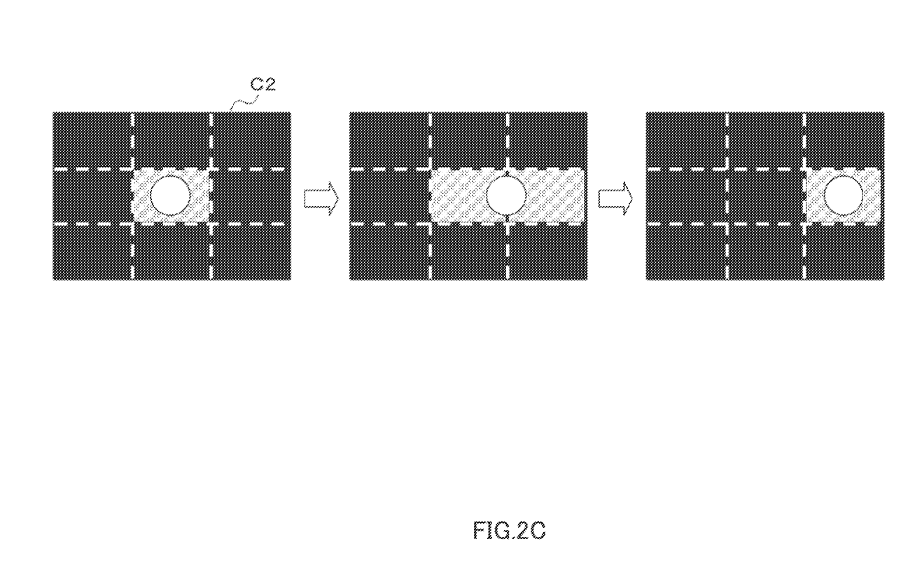

### DESCRIPTION OF EMBODIMENTS

Now, embodiments of the present invention will be described with reference to the accompanying drawings.

### Embodiment 1

Embodiment 1 of the present invention will be described.

A case will be described with the present embodiment where the light emission brightness value of each individual light emitting area is determined by weighted-addition of brightness determination reference values with respct to one or more light emitting areas constituting a weighting area, and, especially, a case will be described here where weighting areas are set on a variable basis according to the speed of motion of image.

<1-1. Configuration of Liquid Crystal Display Apparatus>

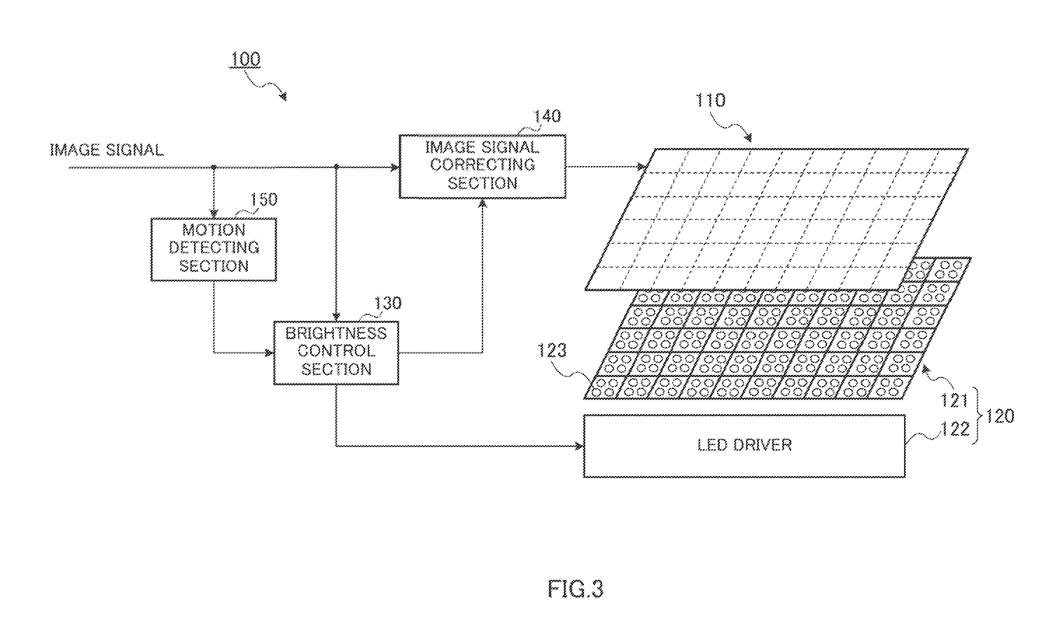

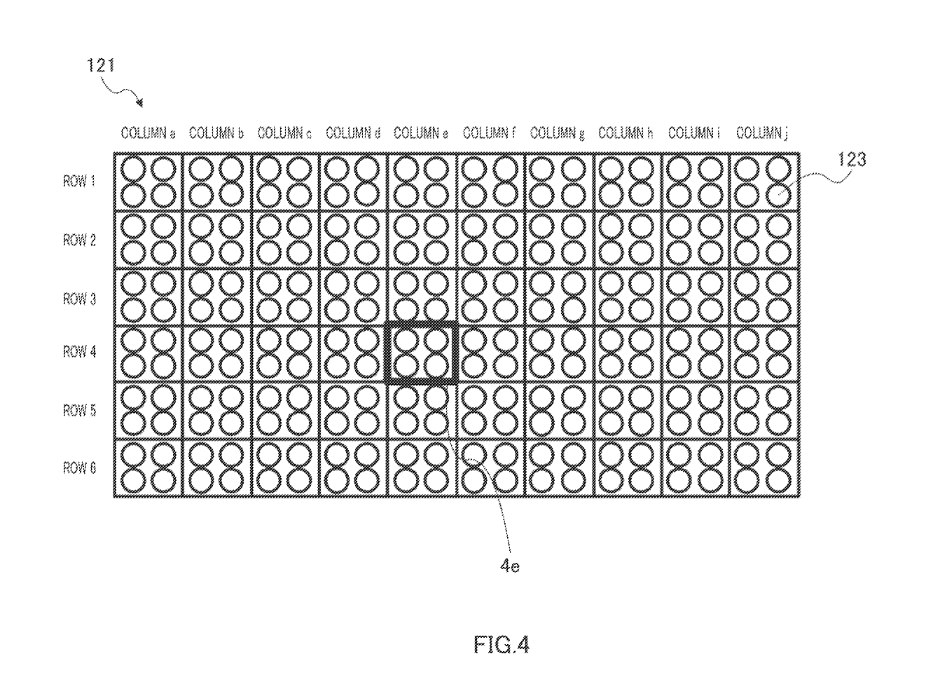

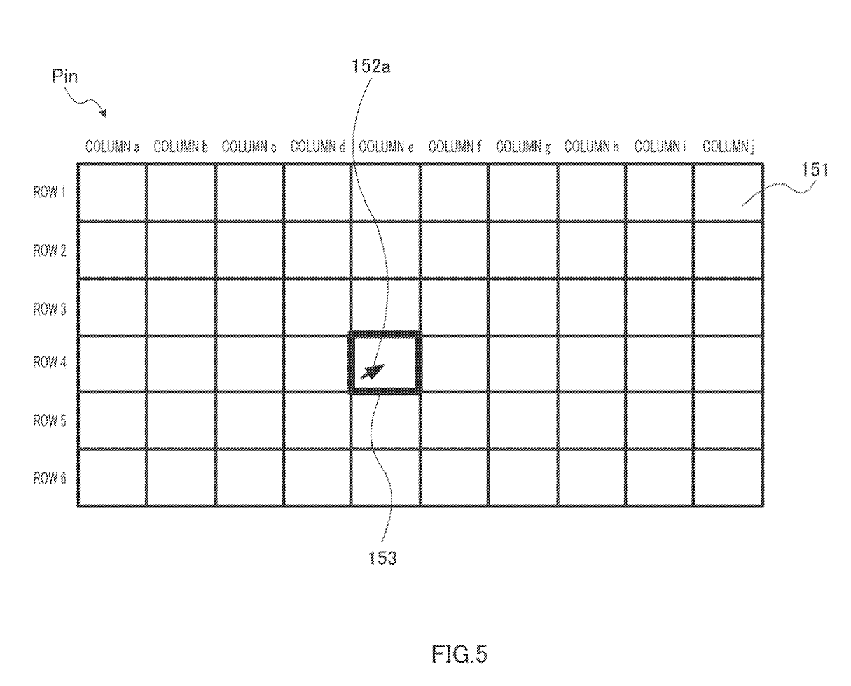

The configuration of a liquid crystal display apparatus will be described first. FIG. 3 is a block diagram showing a configuration of a liquid crystal display apparatus. Liquid crystal display apparatus 100 primarily has liquid crystal panel 110, illuminating section 120, brightness control section 130, image signal correcting section 140 and motion detecting section 150. Illuminating section 120, brightness control section 130 and motion detecting section 150, combined, constitute a backlight apparatus. The individual components will be described below.

<1-1-1. Liquid Crystal Panel>

Liquid crystal panel 110 modulates illumination light emitted from the back in accordance with an image signal, and displays an image. Liquid crystal panel 110 has a plurality of image display areas corresponding to a plurality of light emitting areas (described later), as shown with the broken lines in the drawing. Each image display area has a plurality of pixels.

Liquid crystal panel 110 is formed by providing a liquid crystal layer divided per pixel on a glass substrate. In liquid crystal panel 110, a signal voltage is applied to the liquid crystal layer matching each pixel by a gate driver (not shown), source driver (not shown) and so forth, and the aperture ratio is controlled per pixel. Liquid crystal panel 110 uses the IPS (In Plane Switching) scheme.

The IPS scheme allows liquid crystal molecules to move in a simple fashion, such as rotating in parallel with the glass substrate. Consequently, a liquid crystal panel that employs the IPS scheme allows a wide view angle, and furthermore provides characteristics that color hue does not change much depending on the viewing direction and that color hue does not change much throughout all tonal gradations.

Liquid crystal panel 110 is an example of an, optical modulation section. Other schemes such as the VA (Vertical Alignment) scheme may be employed as the scheme for the liquid crystal panel.

<1-1-2. Illuminating Section>

Illuminating section 120 radiates illuminating light on liquid crystal panel 110 from the back of liquid crystal panel 110, so that liquid crystal panel 110 displays an image.

Illuminating section 120 has light emitting section 121 formed with a plurality of light emitting areas. Each light emitting area is provided in association with an image display area on liquid crystal panel 110 and mainly illuminates the associated image display area. Here, the word “mainly” suggests that each light emitting area may radiate part of its illuminating light on other image display areas which the light emitting area is not associated with. Each light emitting area has four LEDs 123 as a light source. Further, illuminating section 120 has LED driver 122 for driving LEDs 123 of light emitting section 121.

LED driver 22 has driving terminals to equal in number all the light emitting areas, so that it is possible to drive each light emitting area independently.

With the above configuration, illuminating section 120 allows brightness control per light emitting area.

FIG. 4 shows a configuration of light emitting section 121. Light emitting section 121 has a plurality of light emitting areas arranged in a matrix format. A case will be described with the present embodiment where light emitting areas are provided in a matrix arrangement of six rows (row 1 to row 6) and ten columns (column a to column j).

In the following descriptions pertaining to light emitting areas, for example, the light emitting area located in row 4, column e will be referred to as “light emitting area 4e.”

Also, in the following descriptions pertaining to input image and display image, the same notation as the above notation will be used for clarification of positional relationships between partial images or image display area and light emitting areas.

LED 123 emits white light. A plurality of LEDs 123 belonging to one light emitting area are connected to one drive terminal (not shown) in LED driver 122. Consequently, a plurality of LEDs 123 belonging to one light emitting area emit light by the same brightness in accordance with signals from LED driver 122.

Note that LEDs 123 are not limited to ones that directly emit white light. For example, lights of three colors (RGB) may be mixed to emit white light.

Further, although LEDs are used as a light source with the present embodiment, the present invention is by no means limited to this. For example, laser light sources and fluorescent tubes may be used as light sources. That is to say, any light source may be used as long as it is possible to divide light emitting areas and control the light emission brightness of each divided area. In the event a laser light source is used, it is possible to make an area for color reproduction wider. In case where fluorescent tubes are used, it is possible to make a liquid crystal panel thinner compared to the case where LEDs are aligned.

<1-1-3. Motion Detecting Section>

Motion detecting section 150 is an operation processing apparatus to perform operation for detecting the motion of an image—especially the speed of motion of an image—based on an image signal.

For the motion detection method, for example, there is a method of finding a motion vector by pattern matching between with a previous frame with respct to all macro bocks in macro block units. A “macro block” in this context refers to an individual area determined by segmenting an image display area.

For a simpler motion detection method, a method to use the scale of the difference of an image signal from a previous frame in the same pixel position, not pattern matching results, is equally possible.

Motion detecting section 150 calculates motion vector 152a per partial image 151 in each display area of input image Pin, and identifies a range where valid motion is found (hereinafter “motion range”) as a result of this calculation.

Then, with the present embodiment, motion detecting section 150 detects the motion speed of an image based on the motion vector calculated in motion range 153.

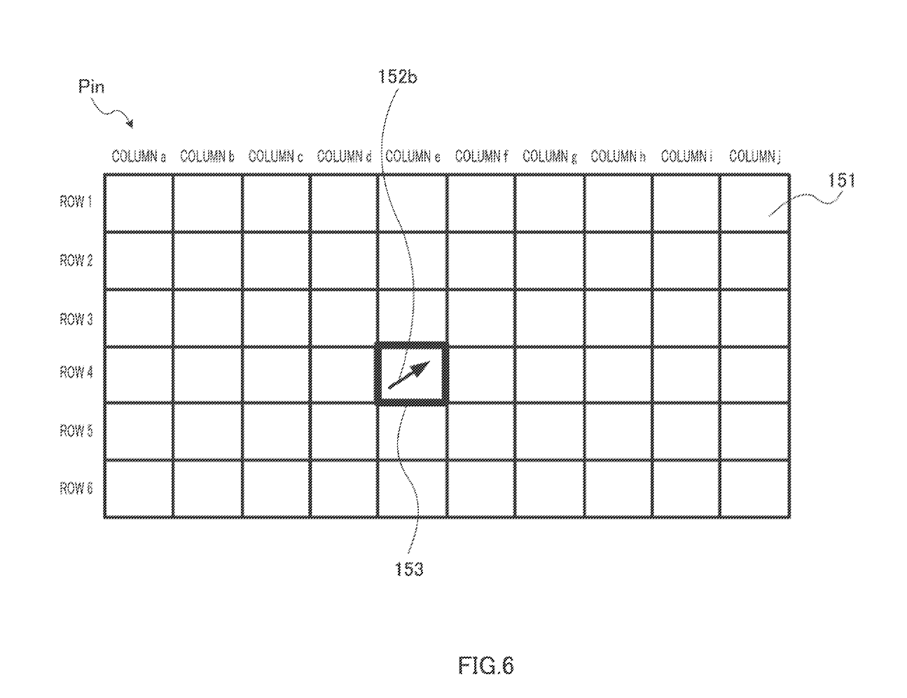

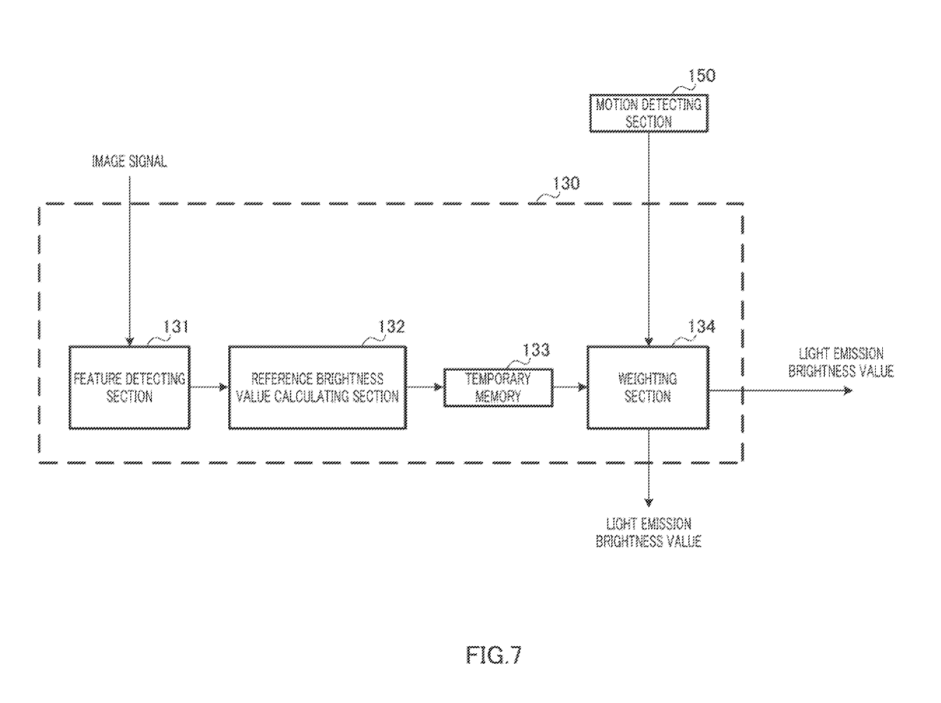

FIG. 5 and FIG. 6 show motion detection results. In each example, identified motion range 153 includes only image display area 4e. Also, comparing the example of FIG. 5 and the example of FIG. 6, the magnitude of motion vector 152b in FIG. 6 is bigger than the magnitude of motion vector 152a in FIG. 5. That is to say, in the example of FIG. 6, the motion of image is faster than in the example of FIG. 5.

As in the examples of FIG. 5 and FIG. 6, when only one image display areas 4e is included in motion range 153, the speed of motion to be detected with respect to this image is equal in magnitude to motion vector 152a and 152b calculated in the partial image in that one image display area 4e.

By contrast with this, when a plurality of image display areas are included in motion range 153, the magnitude of the maximum motion vector amongst the motion vectors calculated in each image display range as the speed of motion of image. Furthermore, it is equally possible to calculate an average motion vector and detect the magnitude of that average motion vector as the speed of motion of image. Also, it is also possible to perform weighted addition of calculated motion vectors and detect the magnitude of the motion vector after the weighted addition as the speed of motion of image.

<1-1-4. Image Signal Correcting Section>

Image signal correcting section 140 is an operation processing apparatus to perform operation for correcting an image signal of each corresponding image display area based on the light emission brightness values of each light emitting area output from brightness control section 130.

When brightness control is performed on a per light emitting area basis, even if the image signal is the same, the brightness of the image might vary depending on how high or low the light emission brightness value of each light emitting area is, and a case might occur where a display image looks unnatural. In order to reduce this, image signal correcting section 140 corrects image signals per corresponding image display area in accordance with the light emission brightness value per light emitting area. To be more specific, image signal correcting section 140 changes contrast gain depending on the degree of change of light emission brightness values. By this means, problems that derive from brightness control per light emitting area such as described above can be alleviated.

Note that, with the present embodiment, it is equally possible to perform brightness control with less image quality deterioration than a conventional liquid crystal display apparatus even when a configuration not providing image signal correcting section 140 is employed.

<1-1-5. Brightness Control Section>

Brightness control section 130 is an operation processing apparatus to perform operation for determining a light emission brightness value per light emitting area. Brightness control section 130 receives an image signal as input per image display area, and outputs a light emission brightness value, per light emitting area, to LED driver 122 of illuminating section 120. Also, brightness control section 130 outputs a light emission brightness value per light emitting area to image signal correcting section 140.

Upon determining the light emission brightness value of one light emitting area, brightness determining section 130 determines the light emission brightness value of that light emitting area, from the values obtained by weighting information (first information) including a brightness determination reference value based on an image signal of a first image display area, and by weighting information (second information) including a brightness determination reference value based on an image signal of a second image display area. The first image display area refers to the image display area that a light emitting area for which the light emission brightness value is determined illuminates mainly. A second image display area refers to an image display area that is different from the image display area which the light emitting area for which the light emission brightness value is determined illuminates mainly.

FIG. 7 is a block diagram showing a configuration of brightness control section 130. Brightness control section 130 primarily has feature detecting section 131, reference brightness value calculating section 132, temporary memory 133 and weighting section 134.

<1-1-5-1. Feature Detecting Section>

Feature detecting section 131 detects the amount of feature in an image signal per image display area. Here, an average value of brightness signals of individual pixels (hereinafter “average brightness value”) will be used as an amount of feature. The brightness signal of each pixel is included in image signals. That is, feature detecting section 31 receives as input an image signal, and detects an average brightness value per image display area. Then, feature detecting section 31 sequentially outputs the detected amounts of feature to brightness calculating section 32.

Further, a peak value (brightness peak value) of the brightness signal of each pixel is substituted or used together with the amount of feature.

<1-1-5-2. Reference Brightness Value Calculating Section>

Brightness calculating section 32 calculates the reference brightness value of each light emitting area, based on the input amount of feature. To be more specific, using a conversion table, brightness calculating section 32 converts an average brightness value into a reference brightness value on a per image display area basis, and outputs this reference brightness value to temporary memory 33. The “reference brightness value” of a light emitting area refers to an example of a brightness determination reference value, which is a value to serve as a reference when the brightness value (that is, light emission brightness value) to apply to a light emitting area of interest is determined.

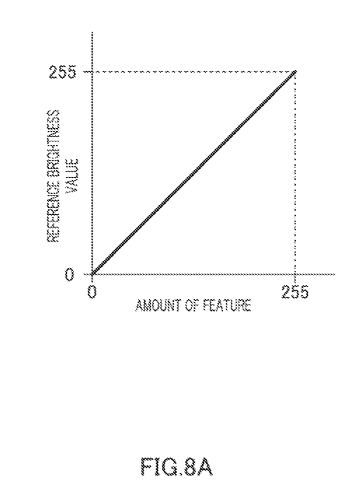

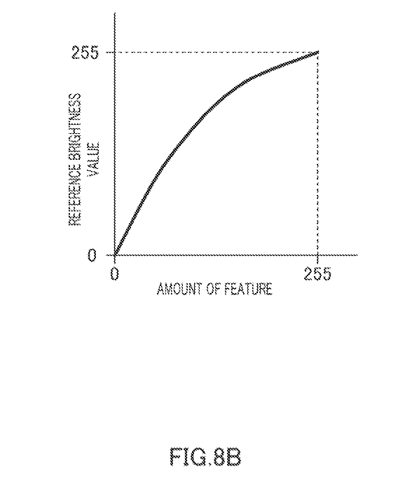

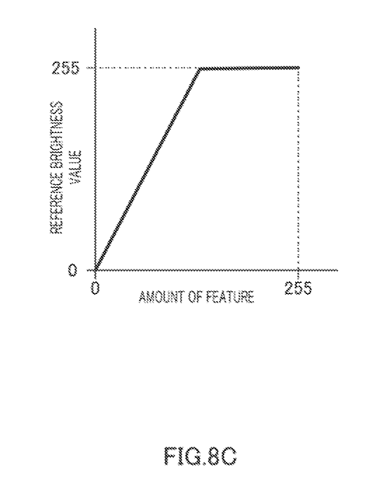

FIG. 8A, FIG. 8B and FIG. 8C show examples of characteristics of conversion tables for converting feature amount into a reference brightness value.

For example, in case where a conversion table having the characteristics shown in FIG. 8A is used, an amount of feature is converted into a reference brightness value of the same value. For example, if the amount of feature is 0, the reference brightness value is also 0, and, if the amount of feature is 255, the reference brightness is also 255. Further, for example, in the event the γ curve of the amount of feature is corrected, it is equally possible to use a conversion table having the characteristics shown in FIG. 8B. Furthermore, in case where the reference brightness value is saturated at or beyond a predetermined feature amount, it is equally possible to use a conversion table having the characteristics shown in FIG. 8C. By using these conversion tables, brightness calculating section 132 can adjust the light emission brightness of light emitting section 121 for an image signal.

For example, in case where an average brightness value is used as an amount of feature, the amount of feature becomes small in an image in which there is a very small white light spot on a black background. Therefore, cases occur where the brightness of the white light spot becomes too low. In such case, a conversion table having the characteristics shown in FIG. 8C makes an image look better than a conversion table having the characteristics shown in FIG. 8A. This is because, with the characteristics shown in FIG. 8C, a comparatively high reference brightness value is returned to an input of a smaller amount of feature.

Accordingly, it is preferable that brightness calculating section 32 provides a plurality of conversion tables of different characteristics in advance, and switches between these conversion tables to use, according to the state of images, to achieve optimal image quality. In this way, brightness calculating section 32 can adaptively switch a conversion table to use to calculate the reference brightness value according to an image.

Further, although a case has been explained with the present embodiment where conversion tables are used, the present invention is not limited to this. For example, using conversion functions having the above-described conversion characteristics, brightness calculating section 132 may convert an amount of feature into a reference brightness value when necessary. According to this configuration, it is possible to reduce the capacity of the memory.

<1-1-5-3. Temporary Memory>

Temporary memory 133 stores brightness determination reference values (reference brightness values with the present embodiment) output from reference brightness value calculating section 132. That is, temporary memory 133 sequentially stores reference brightness values on a per light emitting area basis, and stores the reference brightness values of all light emitting areas on a temporary basis.

<1-1-5-4. Weighting Section>

Weighting section 134 determines the light emission brightness value of the first light emitting area, from the values obtained by applying weights to the reference brightness value of the first light emitting area corresponding to the first image display area (which is the first information) and the reference brightness values of second light emitting areas corresponding to the second image display areas (which is second information). That is, to determine the light emission brightness value of a light emitting area (i.e. the first light emitting area), weighting section 134 retrieves the reference brightness value (i.e. first information) associated with this light emitting area stored in temporary memory 133. Further, weighting section 134 also retrieves from temporary memory 133 the reference brightness values (i.e. second information) of predetermined light emitting areas (i.e. second light emitting areas) apart from that one light emitting area. Then, weighting section 134 applies weights the retrieved reference brightness values, adds up the weighted values and acquires a weighted brightness value, and determines that acquired weighted brightness value as the light emission brightness value of that light emitting area (i.e. the first light emitting area).

Also, weighting section 134 is able to set the configuration of the weighting area comprised of the first light emitting area and second light emitting areas on a variable basis, based on the detection speed of motion.

To be more specific, weighting section 134 sets the weighting area on a variable basis (that is, set the light emitting areas to constitute a weighting area) by making the weighting area bigger or smaller depending on the detected speed of motion and by, in particular, increasing and decreasing the number of second light emitting areas.

There are various techniques to select the second light emitting areas to include in a weighting area. In this case, in the light emitting areas of seven rows and seven column around the first light emitting area, 48 light emitting areas excluding the first light emitting area are defined as second light emitting area candidates and the light emitting areas to serve as second light emitting areas are selected from the second light emitting area candidates. Hereinafter the technique will be described as a premise.

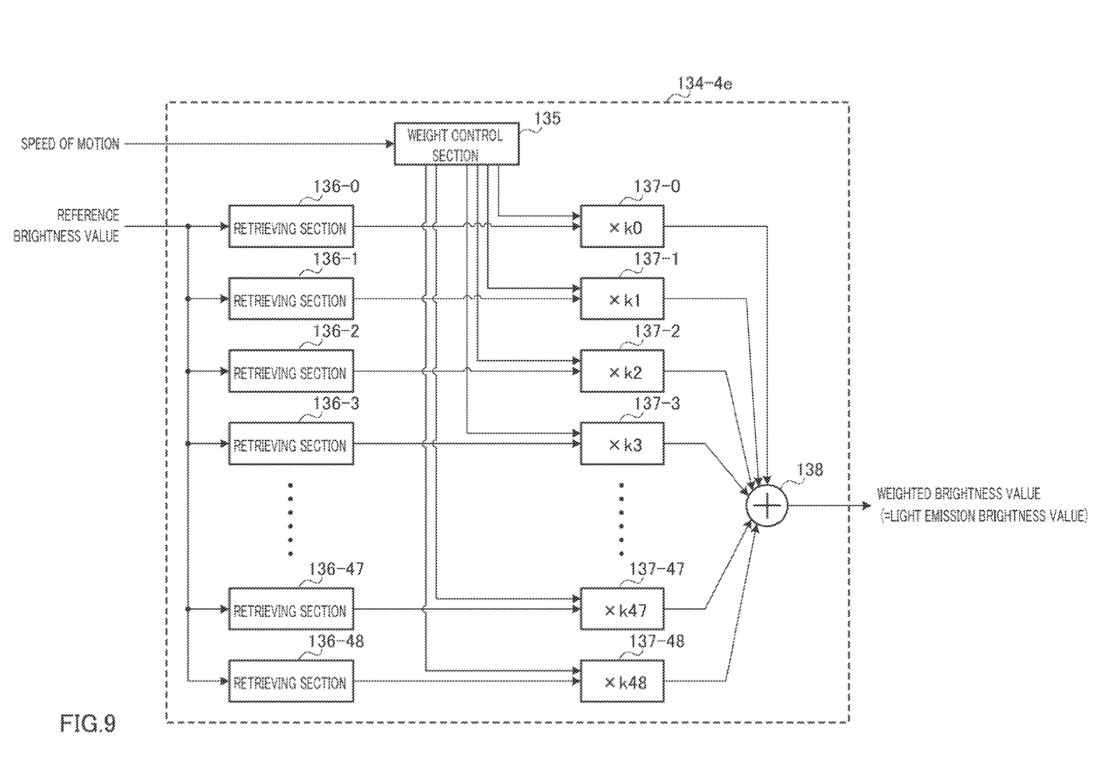

FIG. 9 is a block diagram showing a configuration of weighting section 134. To be more accurate, the configuration of weighting section 134 is a collected body of the configurations shown in FIG. 9. Although the configuration of weighting section 134-4e provided in association with light emitting area 4e will be described here, the same configurations as the weighting section 134-4e is provided for each light emitting area.

Weighting section 134-4e has weight control section 135, forty-nine retrieving sections 136-0 to 136-48, forty-nine multiplying sections 137-0 to 137-48, and adding section 138.

Retrieving section 136-0 corresponds to light emitting area 4e, which is the first light emitting area and forty-eight retrieving sections 136-1 to 136-48 correspond to the forty-eight light emitting areas of second light emitting area candidates that are located around light emitting area 4e.

Retrieving section 136-0 retrieves the reference brightness value of light emitting area 4e from temporary memory 133 and outputs this to multiplying sections 137-0.

Retrieving sections 136-1 to 136-48 each retrieve a reference brightness value for the corresponding second light emitting area candidate from temporary memory 133. To explain illustrated retrieving sections 136-1-136-3, 136-47 and 136-48 as examples, retrieving section 136-1 retrieves the reference brightness value for light emitting area 1b. Retrieving sections 136-2 retrieves the reference brightness value with respect to light emitting area 1c. Retrieving sections 136-3 retrieves the reference brightness value with respect to light emitting area 1d. Retrieving sections 136-47 retrieves the reference brightness value with respect to light emitting area 7g. Retrieving sections 136-48 retrieves the reference brightness value with respect to light emitting area 7h.

Here, light emitting areas 7b to 7h in the second light emitting area candidates for light emitting area 4e are virtual light emitting areas that do not really exist in light emitting section 121. In this case, reference brightness values for nearby light emitting areas that really exist—for example, the reference brightness values for light emitting areas 6b to 6h that really exist near virtual light emitting areas 7b to 7h—are used as reference bright values for light emitting areas 7b to 7h.

Retrieving sections 136-1 to 136-48 output the retrieved reference brightness values to multiplying sections 137-1 to 137-48.

Multiplying sections 137-0 to 137-48 apply weights k0 to k48 output from weight control section 135 to the reference brightness values output from retrieving section 136-0 to 136-48, and outputs the reference brightness values applied weights k0 to k48, to adding section 138.

Adding section 138 calculates the sum of the reference brightness values output from multiplying sections 137-0 to 137-48 as a weighted brightness value. The calculated weighted brightness value is output to LED driver 122 and image signal correcting section 140 as the light emission brightness value of light emitting area 4e.

Weight control section 135 controls weights k0 to k48 which multiplying sections 137-0 to 137-48 use. To be more specific, weight control section 135 sets the configuration of a weighting area in accordance with the speed of motion detected in motion detecting section 150, determines the weights to apply to the reference brightness values calculated with respect to each light emitting area constituting the set weighting area, and outputs weight information to show the determined weights to multiplying sections 137-0 to 137-48.

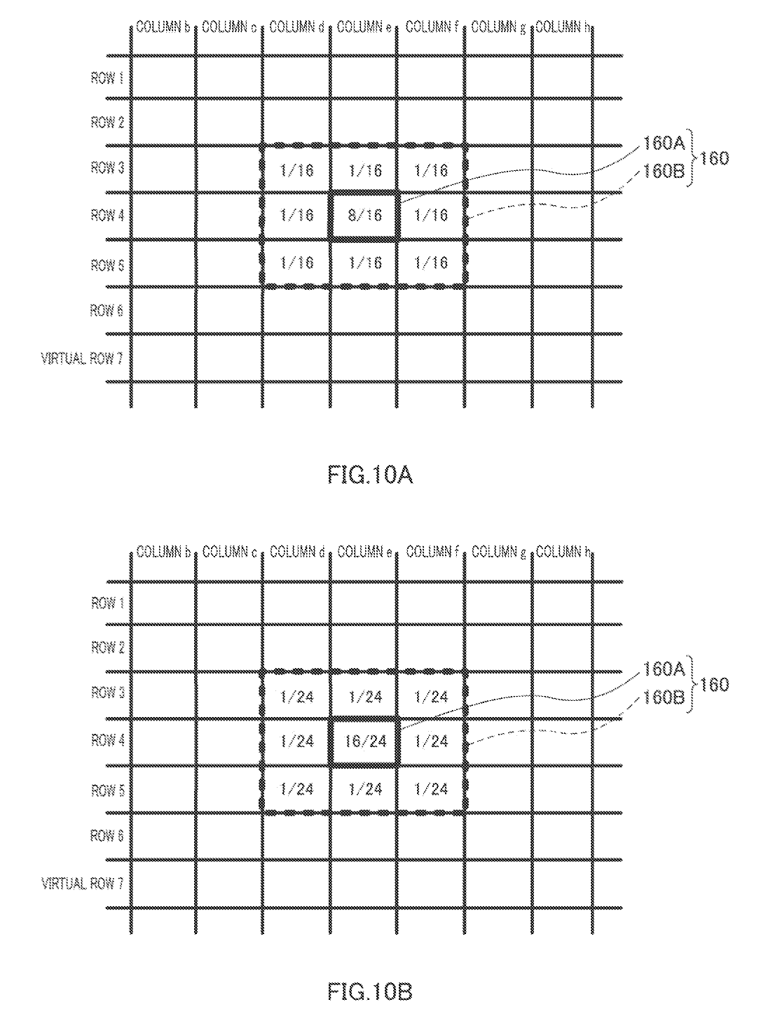

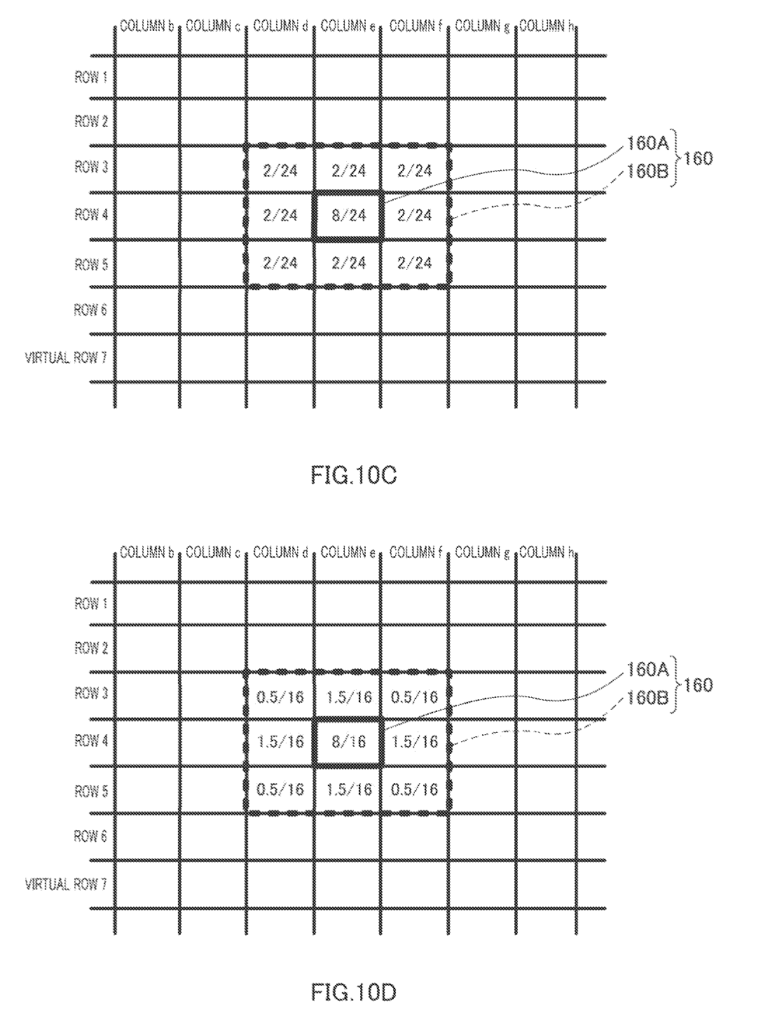

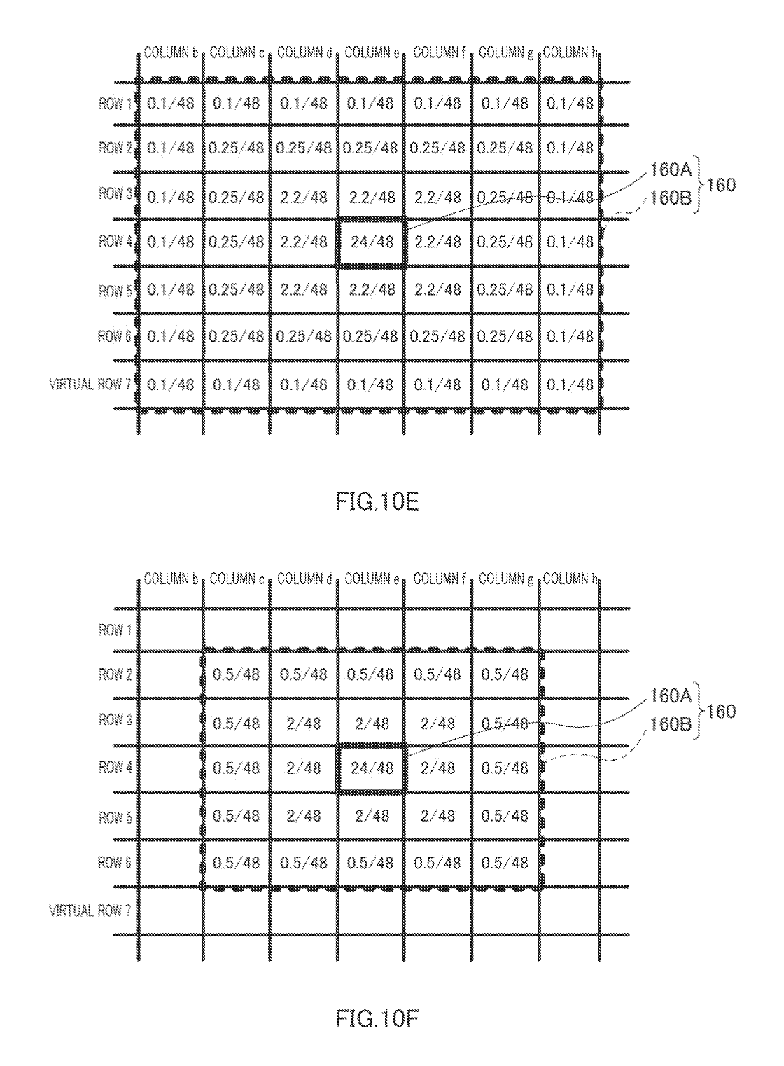

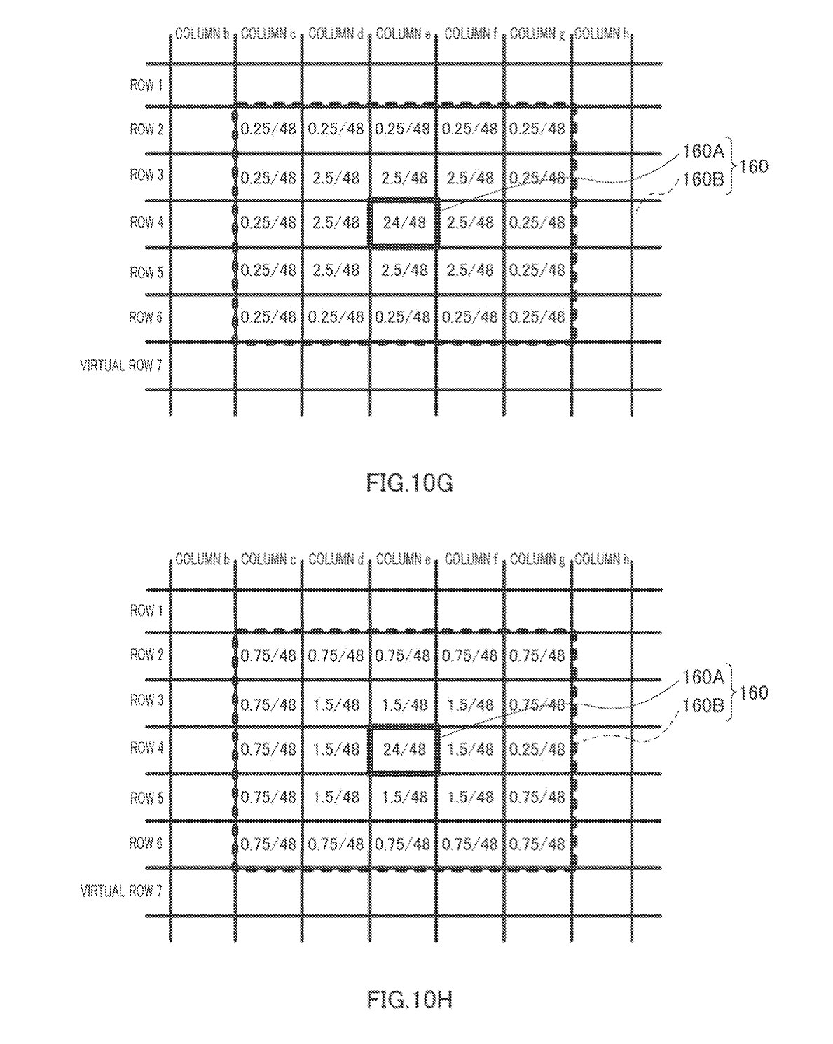

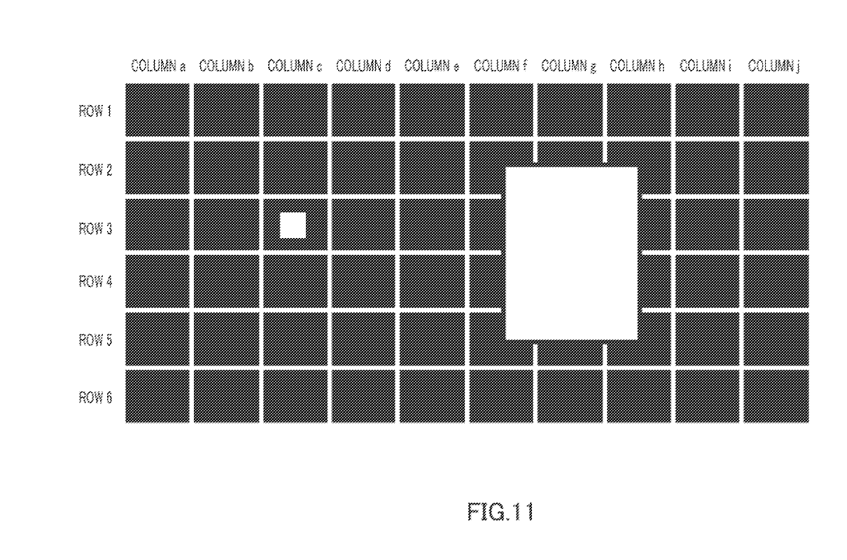

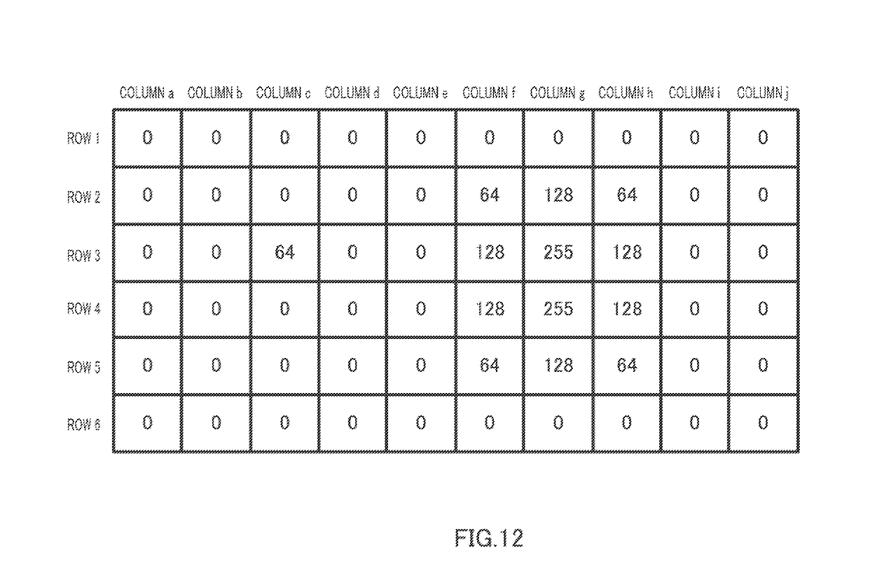

The weight control method in weight control section 135 will be described in detail using several examples with reference to FIG. 10A to FIG. 10H.

FIG. 10A shows the first example of weight control result. The target that is subject to light emission brightness value determination in this example is light emitting area 4e so that first light emitting area 160A is light emitting area 4e. For second light emitting area 160B, eight light emitting areas 3d to 3f, 4d, 4f and 5d to 5f are selected form forty-eight second light emitting area candidates for light emitting area 4e. This selection is made based on the speed of motion of detected speed.

Consequently, in the example of FIG. 10A, areas including light emitting area 4e being first light emitting area 160A and light emitting areas 3d to 3f, 4d, 4f and 5d to 5f being second light emitting area 160B are set as a weighting area 160 with respect to light emitting area 4e.

Then, weight is assigned to first light emitting area 160A and to second light emitting areas 160B, 50% each, so that the sum of all weights is 1, and weight is assigned evenly for all of second light emitting areas 160B.

To be more specific, in the light emitting areas constituting weighting area 160, a weight of 8/16 is determined for light emitting area 4e being the first light emitting area and weight information representing this value is output to the corresponding multiplying section (multiplying section 137-0).

Likewise, in the light emitting areas constituting weighting area 160, a weight of 1/16 is determined for each of light emitting areas 3d-3f, 4d, 4f and 5d to 5f being second light emitting areas, and weight information representing this value is output to the corresponding multiplying sections.

Also, for light emitting areas that do not constitute weighting area 160 are not subject to weighting, so that control is carried out such that “0” weight is output to the corresponding multiplying sections or nothing is output from the corresponding multiplying sections to adding section 138.

As shown with the second example shown in FIG. 10B, it is possible to increase the proportion to assign to first light emitting area 160A or increase the proportion to assign to second light emitting areas 160B as shown with the third example of FIG. 10C. Also, as with the fourth example shown in FIG. 10D, it is equally possible to make distribution to each second light emitting area 160B uneven. Weight control section 135 is adequately switch and use these

Also, with the above fourth example, with light emitting areas 3d, 3f, 5d and 5f, which are diagonally located with respect to light emitting area 4e, the effective distance from light emitting area 4e is slightly longer than light emitting areas 3e, 4d, 4f and 5e that are located up, down, right and left from light emitting area 4e. Consequently, by assigning relatively low weight, it is possible to reduce the influence upon the light emission brightness value of light emitting area 4e relatively small.

FIG. 10E shows a fifth example of weight control result. In this example, again, the target that is subject to light emission brightness value determination is light emitting area 4e so that first light emitting area 160A is light emitting area 4e. For second light emitting area 160B, all the second light emitting area candidates for light emitting area 4e are selected. This selection is made based on the speed of motion of detected speed.

Consequently, in the example of FIG. 10E, areas including light emitting area 4e being first light emitting area 160A and light emitting area 1b-1h, 2h-2h, 3b-3h, 4b-4d, 4f-4h, 5b-5h, 6b-6h and 7b-7h being second light emitting areas 160B, are set as weighting area 160 for light emitting area 4c.

In this case, comparing the example of FIG. 10E with the examples of FIG. 10A-FIG. 10D, greater weighting area 160 is set in the example of FIG. 10E. Narrow weighting areas 160 shown in FIG. 10A to FIG. 10D are set when the detected speed of motion is low—in other words, when the motion of image is low speed (slow). By contrast with this, wide weighting area 160 shown in FIG. 10E is set when the detected speed of motion is high—in other words, when the motion of image is high speed (fast).

FIG. 10F shows a sixth example of weight control result. In this example, again, the target that is subject to light emission brightness value determination is light emitting area 4e so that first light emitting area 160A is light emitting area 4e. For second light emitting area 160B, from all the second light emitting area candidates for light emitting area 4e, twenty-four light emitting areas 2c-2g, 3c-3g, 4c, 4d, 4f, 4g, 5c-5g and 6c-6g are selected. This selection is made based on the speed of motion of detected speed.

Consequently, in the example of FIG. 10F, areas including light emitting area 4e being first light emitting area 160A and light emitting areas 2c-2g, 3c-3g, 4c, 4d, 4f, 4g, 5c-5g and 6c-6g being second light emitting areas 160B, are set as weighting areas 160 for light emitting area 4e.

In this case, comparing the example of FIG. 10F, the examples of FIG. 10A to FIG. 10D and the example of FIG. 10E, in the example of FIG. 10F, weighting area 160 having a medium size is set. That is to say, weighting area 160 of medium width shown in FIG. 10F is set when the detected speed of motion is medium—in other words, when the motion of image is medium.

Thus, weight control section 135 sets the configuration of weighting area 160 on a variable basis by making weighting area 160 bigger or smaller in accordance with the detected speed of motion.

Also, as shown with the seventh example shown in FIG. 10G and the eighth example shown in FIG. 10H, and the assignment to each second light emitting area 160B is switched adaptively.

The configuration of liquid crystal display apparatus 100 has been explained.

<1-2. Operation of Liquid Crystal Display Apparatus>

Next, a specific example of operation of a liquid crystal display apparatus having the above configuration will be described primarily focusing upon characteristic operations.

<1-2-1. Calculation of Reference Brightness Value>

FIG. 11 shows an example of an image to input to liquid crystal panel 10 where two 100%-white rectangular objects, big and small, are placed on a black background.

The image signal of the image shown in FIG. 11 is inputted to feature detecting section 131 in brightness determining section 130, and its average brightness value, which is an amount of feature, is detected per image display area. Then, each detected feature amount is inputted to brightness calculating section 132 and is converted into the reference brightness value of each light emitting area.

FIG. 12 shows the reference brightness value of each light emitting area of light emitting section 121 which is calculated in brightness calculating section 132. Note that brightness calculating section 132 used here has the conversion table having the characteristics shown in FIG. 8A. Consequently, an amount of feature is converted into a value of the same value as the reference brightness value. For example, if the amount of feature is 0, the reference brightness value is 0, if the amount of feature is 128, the reference brightness value is 128, and, if the amount of feature is 255, the reference brightness value is 255.

The numerical values in FIG. 12 will be explained in details using light emitting area 3c as an example. In case of light emitting area 3c, the smaller rectangular object in FIG. 11 is a 100%-white image. Therefore, the brightness signal of each pixel included in an image signal showing an object part has a maximum value of 255. The smaller rectangular object in FIG. 11 occupies ¼ of the area of image display area 3c. That is, in ¼ of the pixels of image display area 3c, the brightness signal shows “255.” Therefore, with respect to light emitting area 3c, an average brightness value of 64 is determined as the amount of feature, and a reference brightness value or 64 is calculated.

The bigger rectangular object in FIG. 11 will be described in a similar fashion. In light emitting areas 3g and 4g, brightness signals are 255 in all pixels of image display areas 3g and 4g.

In light emitting areas 2g, 3f, 3h, 4f, 4h and 5g, the brightness signals are 255 in half of the pixels of image display areas 2g, 3f, 3h, 4f, 4h and 5g. Consequently, with respect to these light emitting areas, feature amount 128, which is half of the brightness signals, is calculated.

In light emitting areas 2f, 2h, 5f and 5h, corresponding to the four corners of the rectangular object, the brightness signals are 255 in ¼ of the pixels of image display areas 2f, 2h, 5f and 5h. Consequently, with these light emitting areas, a feature amount of 64, which is ¼ of the value of a brightness signal, is detected, and a reference brightness value of 64 is calculated.

<1-2-2. Applying Weight>

Next, the operation of weighting, which is calculated upon calculating a light emission brightness value from a reference brightness value, will be described.

Here, to clarify the function of the present invention, first, a case where weighting is not performed, will be explained for comparison.

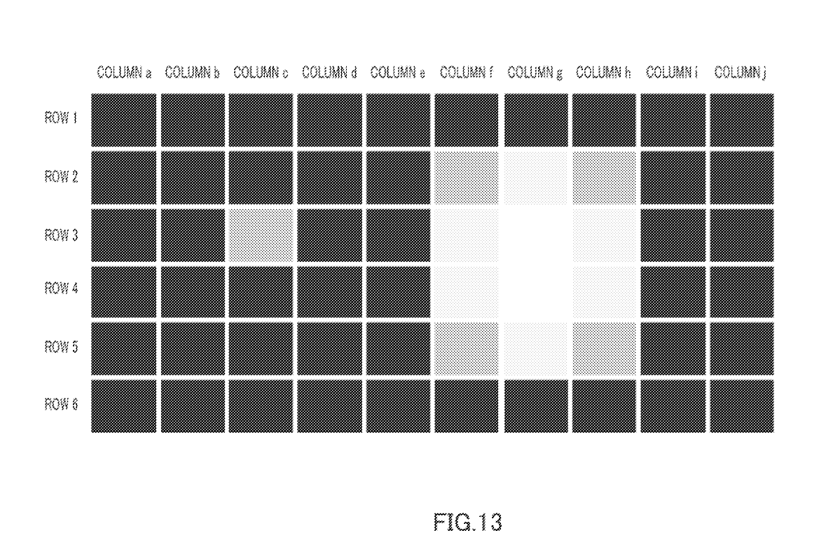

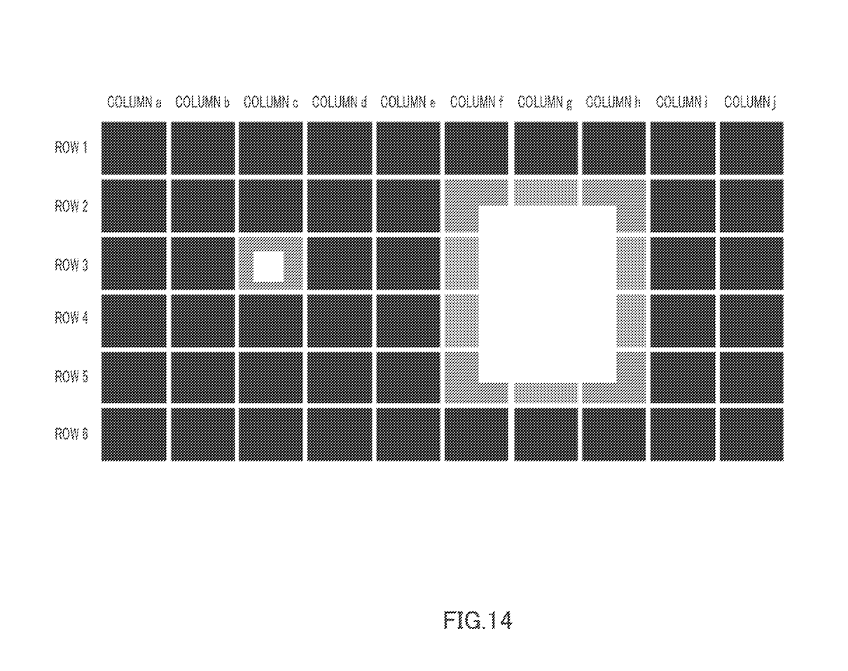

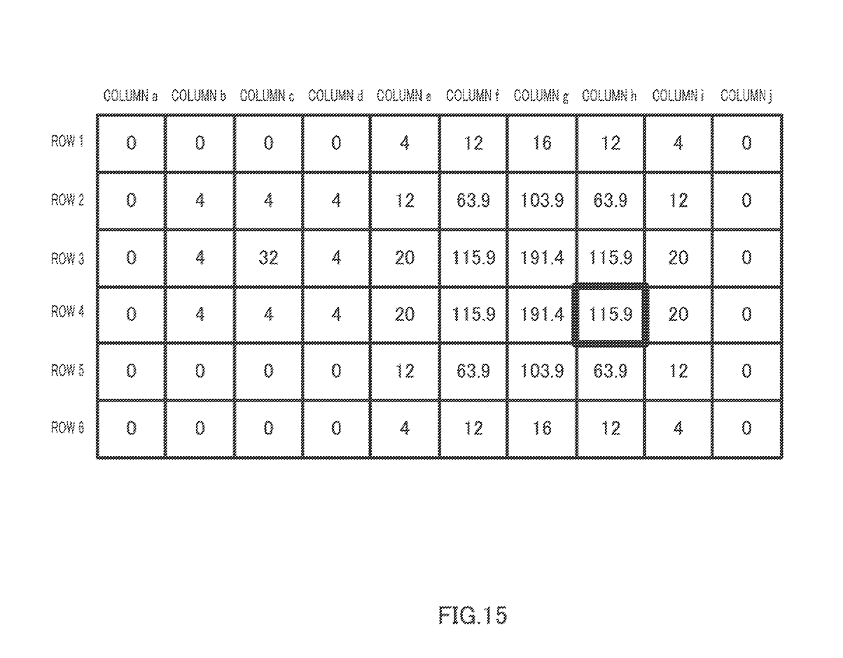

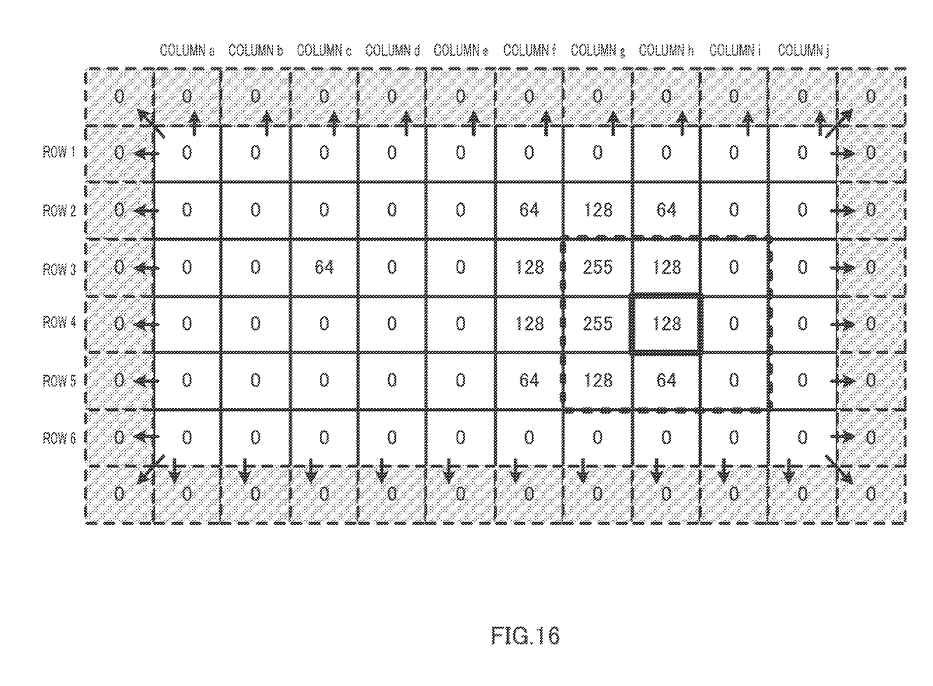

FIG. 13 shows the light emitting state of light emitting section 121 in case where the reference brightness values shown in FIG. 12 are inputted to illuminating section 120 as is without passing through weighting section 134. Further, FIG. 14 shows an image that is actually displayed on liquid crystal panel 10 when light in FIG. 13 illuminates liquid crystal panel 10 from its back.

As shown in FIG. 14, upon comparison of a light emitting area (for example, light emitting area 1g) that is not emitting light and light emitting area 2g that is emitting light, the black part in image display area 2g becomes bright and distinct. That is, image display area 2g shows an undesirable display with visible “impure black.” This results from the difference between the light emission brightness values of light emitting areas that are not emitting light and light emitting areas that are emitting light. Unlike the black part, the white part has uniform brightness, because the brightness signal is corrected in image signal correcting section 140.

Next, a case to perform weighting will be explained.

FIG. 15 shows weighted brightness values outputted from weighting section 134. The calculation of numerical values in FIG. 15 will be explained in details using FIG. 16.

FIG. 16 illustrates calculation of numerical values of reference brightness values before the reference brightness values are inputted to weighting section 134. For example, in case of light emitting area 4h, the reference brightness value corresponding to the first information is 128 as shown in FIG. 16. The second information of light emitting area 4h includes each reference brightness value of eight surrounding light emitting areas 3g, 3h, 3i, 4g, 4i, 5g, 5h and 5i.

Here, in the even the same weights as the weights shown in FIG. 10A are used, the corresponding multiplying section performs 8/16 weighting with respect to the first information. That is, the value of 128×( 8/16) is derived with respect to light emitting area 4h. For second information, the corresponding multiplying sections perform 1/16 weighting. That is to say, the value of 255×( 1/16) is derived with respect to light emitting areas 3g and 4g, the value of 128×( 1/16) is derived with respect to light emitting areas 3h and 5g, the value of 64×( 1/16) is derived with respect to light emitting area 5h, and the value of 0×( 1/16) is derived with respect to light emitting areas 3i, 4i and 5i.

Then, a sum of 115.9 is calculated by adding these nine values, as the weighted brightness value for light emitting area 4h, and this light emission brightness value is output.

By calculating the light emission brightness values of all light emitting areas according to the same method, the light emission brightness values shown in FIG. 15 are acquired.

Note that there are no light emitting areas in one of eight directions of the light emitting areas at the end parts of light emitting section 121 (the light emitting areas belonging to row 1, row 6, column a and column j). Therefore, as shown in FIG. 16, weighting section 134 calculates the light emission brightness values with respect to these light emitting areas at the end parts by using virtual light emitting areas that extend in the row direction and column direction assuming that there are light emitting areas in eight surrounding directions of all light emitting areas, and calculates a weighted brightness value.

That is, weighting section 134 adds one row of virtual light emitting areas having the same reference brightness value as in row 1, to the upper side of row 1, and adds one row of virtual light emitting areas having the same reference brightness value as in row 6, to the lower side of row 6. Then, weighting section 134 adds one column of virtual light emitting areas having the same reference brightness value as in row a, to the left side of column a, and adds one column of virtual light emitting areas having the same reference brightness values as in column j, to the right side of column j. Further, weighting section 134 extends the light emitting areas at the four corners of light emitting section 121 to use as light emitting areas corresponding to the four corners of the extended virtual area.

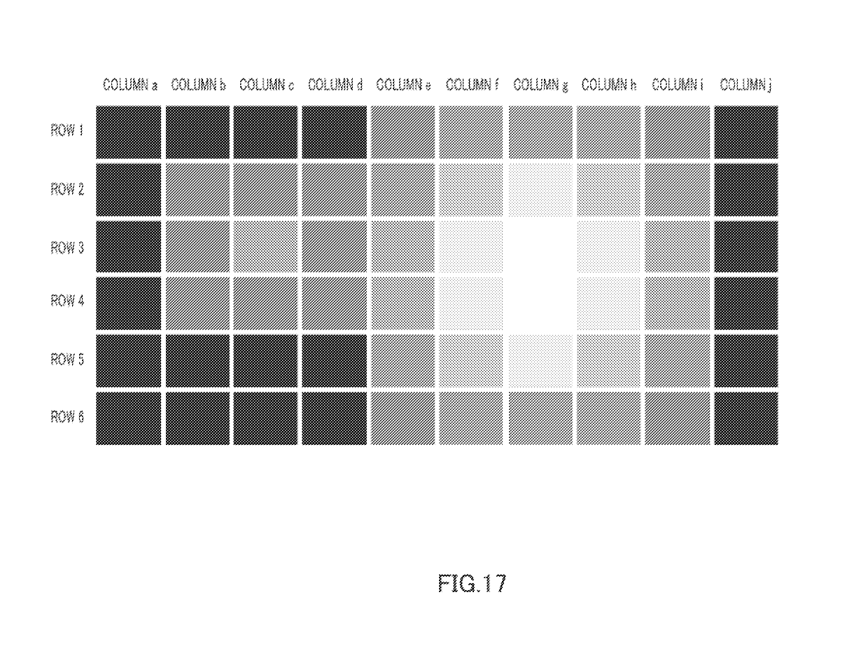

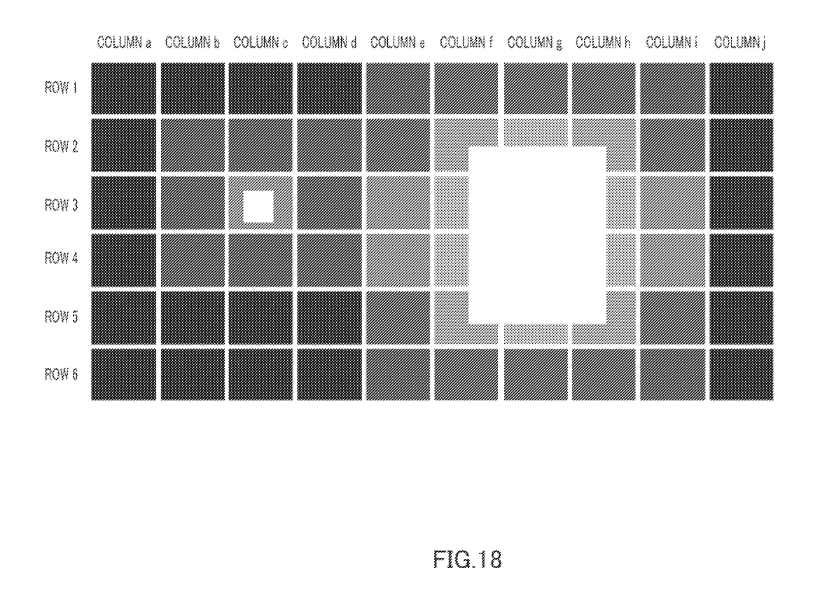

FIG. 17 shows the light emitting state of illuminating section 121 in case where the weighted brightness value (=light emission brightness value) shown in FIG. 15 are inputted in illuminating section 120. Further, FIG. 18 shows an image that is actually displayed on liquid crystal panel 110 when light in FIG. 17 illuminates liquid crystal panel 110 from its back.

As shown in FIG. 18, in case where weighting section 134 is used, the difference in light emission brightness values is alleviated between the light emitting areas that are not emitting light and light emitting area that is emitting light compared to FIG. 14 showing a case where weighting section 134 is not used. By this means, “impure black” is alleviated.

<1-2-3. Variable Setting of Weighting Area>

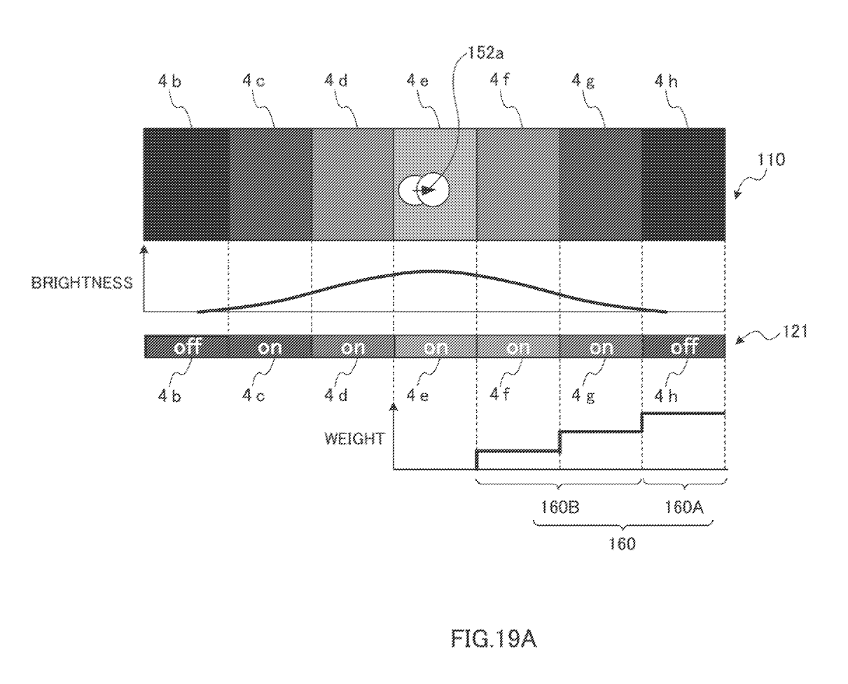

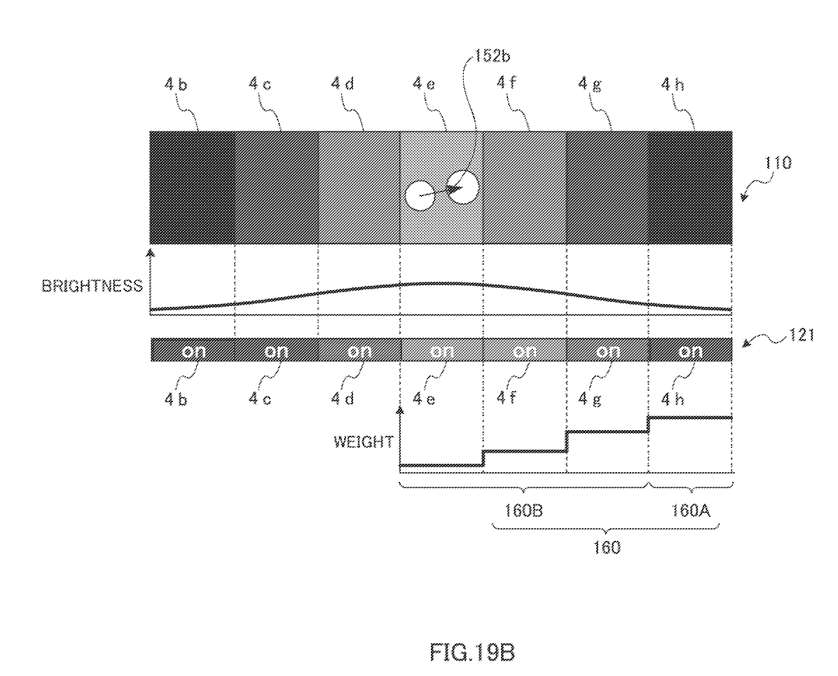

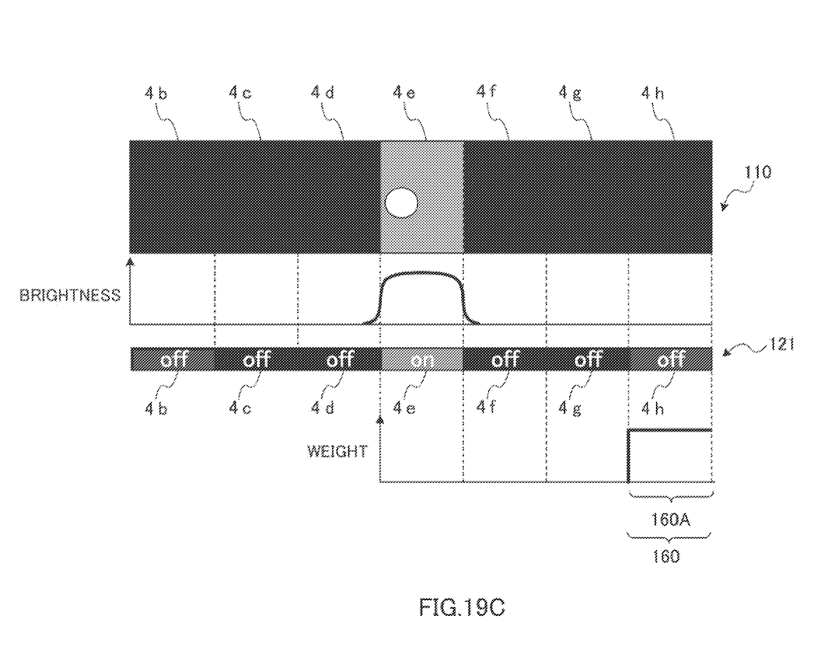

Next, the variable setting of weighting areas performed by weight control section 135 of weighting section 134 will be explained with reference to three setting examples using FIG. 19A, FIG. 19B and FIG. 19C.

The three setting examples to be described below presume a case where an image of a black background is received as input in which a circular object of a high peak brightness is present in image display area 4e that image—that is, presumes a case where the reference brightness values are 0 except for light emitting area 4e. Furthermore, for ease of explanation, light emitting area 4b to 4h in light emitting section 121 or image display areas 4b to 4h in Liquid crystal panel 110 will be primarily described.

In the first example shown in FIG. 19A, motion detection result such as described with reference to FIG. 5 is obtained in motion detecting section 150. That is to say, motion vector 152a which represents that there is meaningful motion in an image is calculated, and its magnitude, which represents that the motion of that image exhibits medium speed, is detected.

Depending on this detection result, weight control section 135 performs weighting area setting. Weighting area setting is performed for each light emitting area.

Upon determining the light emission brightness value for light emitting area 4h, first light emitting area 160A is light emitting area 4h, as illustrated in the drawing. Then, as for second light emitting areas 160B, given the detected motion exhibits medium speed, two light emitting areas 4e and 4g are selected from the illustrated second light emitting area candidates (light emitting areas 4e to 4g).

Consequently, in light emitting area 4h, light emitting areas 4f to 4h constitute weighting area 160. Light emitting area 4e is not subject to weighting for determining the light emission brightness value of light emitting area 4h. Consequently, the light emission brightness value determined with respect to light emitting area 4h is influenced only by light emitting areas 4f to 4h in which the reference brightness value is 0, and are not influenced by light emitting area 4e in which the reference brightness value is not 0.

By contrast with this, light emitting area 4c, 4d, 4f and 4g all have a reference brightness value of “0,” but the light emission brightness values determined with respect to these light emitting area 4c, 4d, 4f and 4g are influenced by light emitting area 4e in which the reference brightness value is not 0 and do not become 0. Also, in light emitting area 4e the brightness reference value is not 0, so that the light emission brightness value to be determined is not 0 either.

As a result of this, light emitting areas 4b and 4h are turned off in accordance with “0” light emission brightness values. Also, light emitting areas 4c to 4g emit light in accordance with light emission brightness values that are not 0. By this means, it is possible to achieve brightness change in which a moderate and wide brightness curve is formed.

In the second example shown in FIG. 19B, motion detection results such as shown in FIG. 6 are acquired in motion detecting section 150. That is to say, motion vector 152b which represents that there is meaningful motion in an image is calculated, and its magnitude, which represents that the motion of that image exhibits high speed, is detected.

When the light emission brightness value with respect to light emitting area 4h is determined based on the above detection result, the detected motion exhibits high speed in second light emitting areas 160B, so that all of the illustrated second light emitting area candidates, namely three light emitting areas 4e to 4g, are all selected.

Consequently, for light emitting area 4h, light emitting areas 4e to 4h constitute weighting area 160. That is to say, light emitting area 4e is subject to weighting for determining the light emission brightness value with respect to light emitting area 4h. Consequently, the light emission brightness values determined with respect to these light emitting area 4b to 4h are influenced by light emitting area 4e in which the reference brightness value is not 0 and do not become 0.

As a result of this, light emitting areas 4b to 4h emit light in accordance with light emission brightness values which are not 0. By this means, as illustrated, it is possible to achieve brightness change in which a moderate and wide brightness curve is formed.

In the third example shown in FIG. 19C, no meaningful motion is detected in the image.

When the light emission brightness value of light emitting area 4h is determined based on this motion detection result, given that no motion is detected in second light emitting areas 160B, none of the illustrated second light emitting area candidates (light emitting areas 4e to 4g) is selected.

Consequently, with light emitting area 4h, light emitting area 4h alone constitutes weighting area 160. Consequently, the light emitting value to be determined with respect to light emitting areas 4h is influenced only by light emitting area 4h in which the reference brightness value is 0, and therefore becomes 0. The same applies to light emitting areas 4b-4d, 4f and 4g.

As a result of this, light emitting areas 4e alone emits light in accordance with a light emission brightness value that is not 0, and the rest of 4b-4d and 4f-4h are turned off in accordance with light emission brightness values which are 0. By this means, as illustrated, it is possible to achieve brightness change in which a steep and narrow brightness curve is formed.

Thus, a weighting area is set on a variable basis so that a wider weighting area is set when faster image motion is found. The visibility of flicker, which relies upon impure black, changes significantly in accordance with the speed of motion of an image object. That is to say, with still images and very slow motion, the cycle of flicker becomes very long, and therefore flicker is less visible. By contrast with this, the cycle becomes short with fast movie, hence high visibility of flicker. Consequently, by the above setting of a weighting area on a variable basis, it is possible to make flicker due to impure black difficult to see.

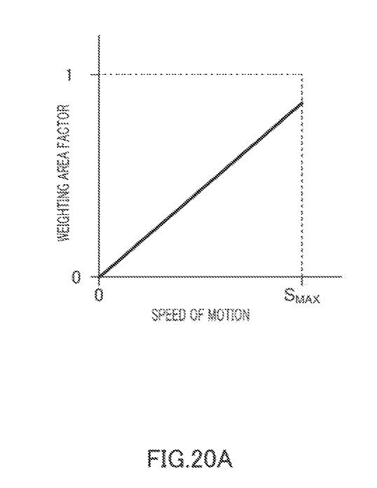

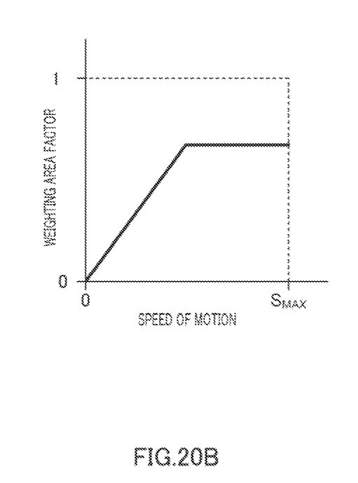

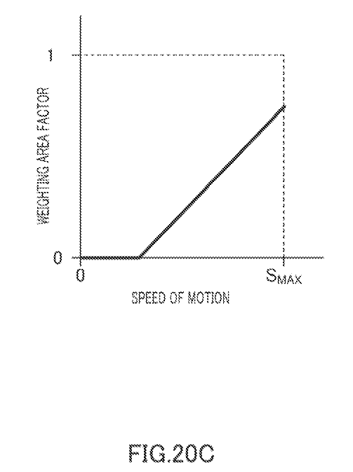

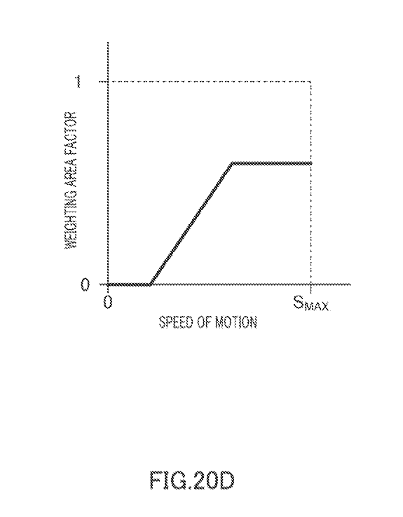

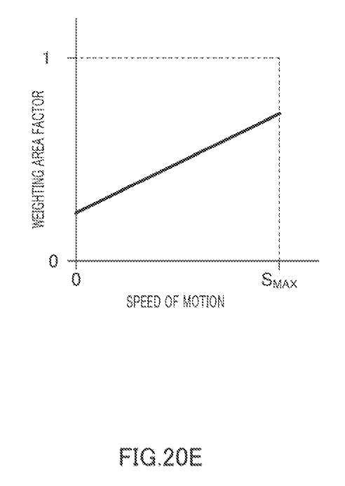

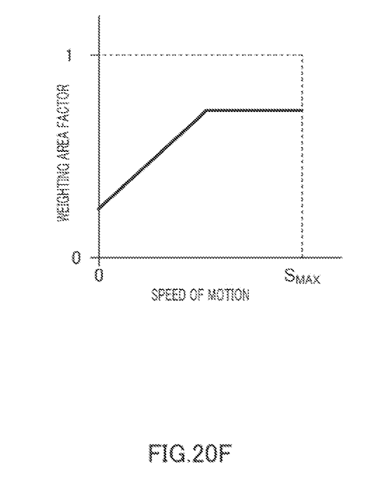

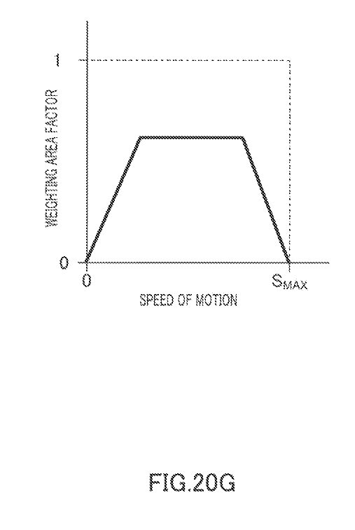

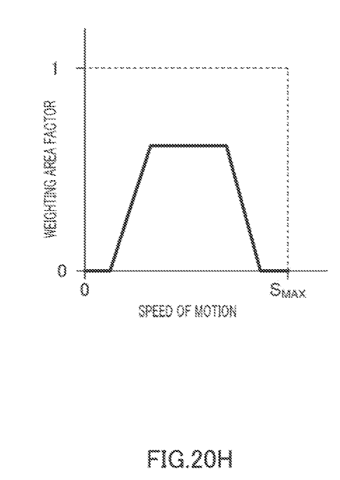

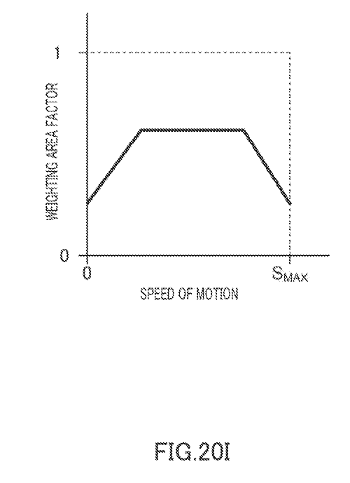

For a weighting area setting method for setting a wider weighting area for faster image motion, various methods are possible, as shown in FIG. 20A to FIG. 20I, for example.

In FIG. 20A to FIG. 20I. S_{MAX} is the maximum value of speed of motion that can be detected. Also, the weighting area factor shows the proportion of the number of light emitting areas to be selected as second light emitting areas to the number of second light emitting area candidates.

That is to say, when the weighting area magnification factor is 0, none of the second light emitting area candidates is selected as a second light emitting areas, and as a result of this, the weighting area include only the first light emitting area. If the weighting area factor is all of the second light emitting area candidates are selected as second light emitting areas, and, as a result, the weighting area includes the first light emitting area and all of the second light emitting area candidates. When the weighting area factor is greater than 0 and smaller than 1, a number of light emitting areas to equal that value, located relatively close to the first light emitting area, are selected, from the second light emitting area candidates.

<1-3. Summary of Features>

Next, the characteristic advantages of the liquid crystal display apparatuses of the present embodiment will be described.

First, with the present embodiment, upon determining the light emission brightness value of a certain light emitting area, weighting is performed taking into account the reference brightness values of surrounding light emitting areas, in addition to the reference brightness value of the light emitting area of interest. By this means, difference in brightness between neighboring light emitting areas is reduced, so that it is possible to reduce impure black.

Also, for example, with the conventional liquid crystal display apparatus disclosed in patent literature 1, when a light emitting area of high brightness and a light emitting area of low brightness neighbor each other in an input image signal (especially a light emitting area with a brightness value close to 0), whether or not to correct the light emission brightness value of the light emitting area of low brightness is decided by comparing their difference in brightness with a threshold. So, as described earlier, there is a possibility that a discontinuous point in brightness is created in time.

By contrast with this, the present embodiment does not use a threshold such as this, and so no discontinuity of brightness is created.

Furthermore, with the present embodiment, the motion of an image is detected, and, based on the detected motion of the image (especially the speed of motion with the present embodiment), the configuration of a weighting area is set on a variable basis. Although the visibility of flicker due to impure black changes with the speed of motion in an image, it is possible to make flicker less visible by setting the weighting area on a variable basis in accordance with the speed of motion in an image.

Also, if a light emitting area of high brightness and light emitting area of low brightness (especially a light emitting area having a brightness value close to 0) neighbor each other in an input image signal, with the conventional art, the brightness of the light emitting area of low brightness is corrected upward, without correcting the brightness value of the light emitting area of high brightness.

By contrast with this, with the present embodiment, the light emission brightness value of the light emitting area of high brightness is lowered, an the light emission brightness value of the light emitting area of low brightness is increased. This brings about an effect of suppressing power increase by correction compared to the prior art.

In particular, with the present embodiment, an average brightness value is used as an amount of feature. By using an average brightness value as an amount of feature, as shown in FIG. 17, the brightness of light emitting areas corresponding to the smaller white object becomes lower than the light emitting areas corresponding to the larger white object. Consequently, if an image signal is not corrected, the brightness of a display image becomes lower with respect to the bigger white object than the smaller white object.

Generally speaking, if the brightness is the same, the human eye tends to perceive a smaller white object brighter than a bigger white object. Consequently, even when an average brightness value is used as an amount of feature, a natural display image is provided. It is equally possible to correct an image signal such that the difference in brightness between a larger white object and a smaller white object is reduced.

### Variation of Embodiment 1

With embodiment 1, a reference brightness value is determined as a brightness determination reference value by converting the amount of feature, and, by weighted addition of reference brightness values acquired, a light emission brightness value is calculated.

By contrast with this, according to the variation described below, a weighted amount of feature is calculated as a brightness determination reference value by means of weighted addition of amounts of feature, and a light emission brightness value is determined by converting the weighted amount of feature calculated.

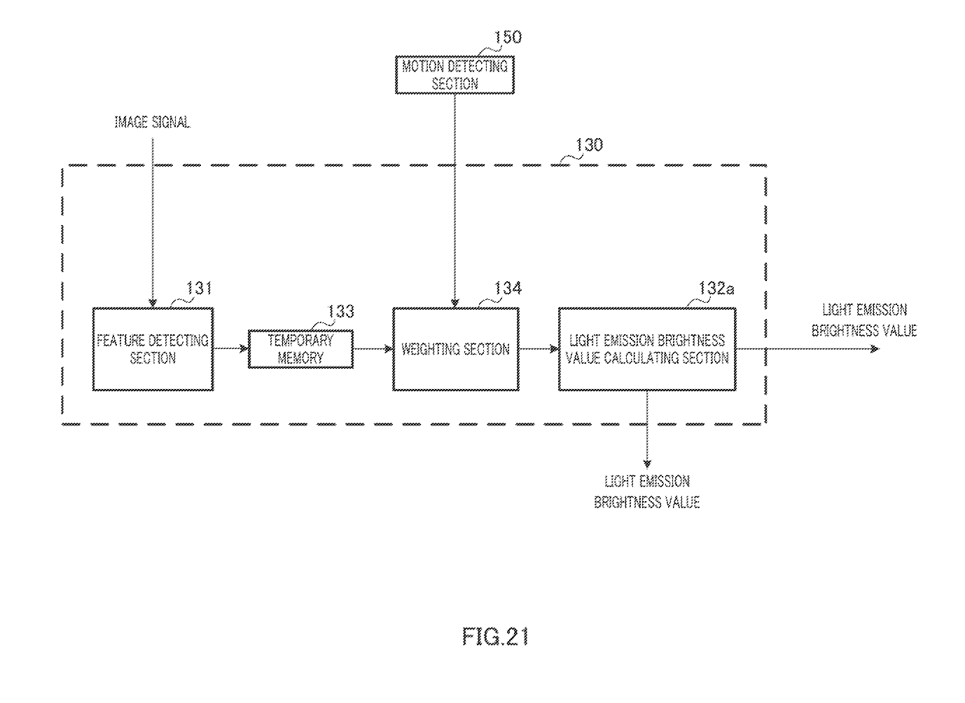

FIG. 21 is a block diagram showing a configuration of brightness control section 130 according to the present variation. With this variation, brightness control section 130 primarily has feature detecting section 131, temporary memory 133, weighting section 134 and light emission brightness value calculating section 132a. Hereinafter differences from brightness control section 130 of embodiment 1 will be primarily described.

Feature detecting section 131 sequentially outputs the amount of feature to temporary memory 133. In this example of variation, the amount of feature per image display area is an example of a brightness determination reference value which servers as the reference upon determining the light emission brightness value of a light emission period of interest.

Temporary memory 133 stores the brightness determination reference values output from feature detecting section 131 on a per light emitting area basis (in this example of variation, amounts of feature per corresponding image display area).

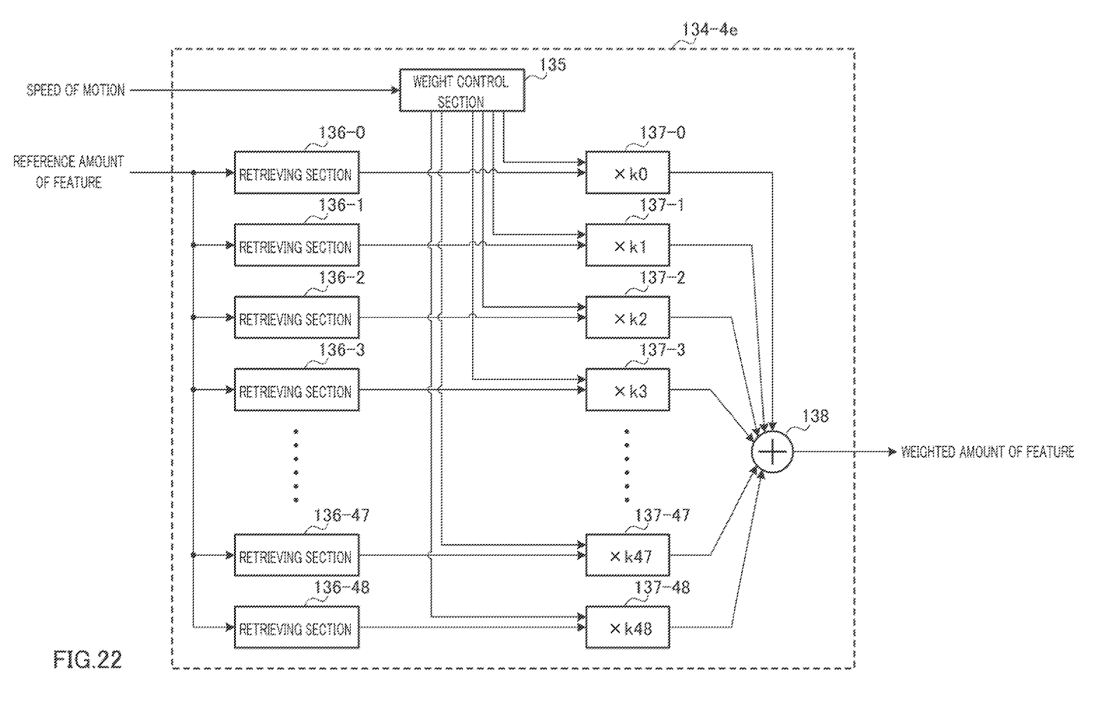

Weighting section 134 is a collected body of configurations shown in FIG. 22. Although the configuration of weighting section 134-4e provided in association with light emitting area 4e will be described here, the same configurations as the weighting section 134-4e is provided for each light emitting area.

Weighting section 134-4e has weight control section 135, forty-nine retrieving sections 136-0 to 136-48, forty-nine multiplying sections 137-0 to 137-48, and adding section 138.

Retrieving section 136-0 retrieves the amount of feature in image display area 4e, which is the reference brightness value of light emitting area 4e, from temporary memory 133, and outputs this to multiplying sections 137-0.

Retrieving sections 136-1 to 136-48 each read the feature of amount in an image display area corresponding to a related second light emitting area candidate, from temporary memory 133. To describe illustrated retrieving sections 136-1-136-3, 136-47 and 136-48 as an example, retrieving section 136-1 retrieves the amount of feature in image display areas 1b. Retrieving section 136-2 retrieves the amount of feature of image display area 1c. Retrieving section 136-3 retrieves the amount of feature of image display area 1d. Retrieving section 136-47 retrieves the amount of feature of image display area 7g. Retrieving section 136-48 retrieves the amount of feature of image display area 7h.

In this case, feature amounts in nearby light emitting areas that really exist—for example, the amounts of feature in to image display areas neighboring virtual image display areas—the are used as feature amounts in virtual image display areas that do not really exist.

Retrieving sections 136-1 to 136-48 output the retrieved feature amounts to multiplying sections 137-1 to 137-48, respectively.

Multiplying sections 137-0 to 137-48 applies weights k0 to k48, represented by weight information output from weight control section 135, to the feature amounts output from retrieving sections 136-0 to 136-48, and outputs the feature amounts applied weights k0 to k48, to adding section 138.

Adding section 138 calculates the sym of the amounts of feature output from multiplying sections 137-0 to 137-48 as a weighted amount of feature. The calculated weighted amount of feature is output to light emission brightness value calculating section 132a.

Weight control section 135 controls weights k0 to k48 to use in multiplying sections 137-0 to 137-48. To be more specific, weight control section 135 sets the configuration of a weighting area in accordance with the speed of motion detected in motion detecting section 150, determines the weights to apply to the reference brightness value calculated with respect to each light emitting area constituting the set weighting area, and outputs weight information to show the determined weights, to multiplying sections 137-0 to 137-48.

Light emission brightness value calculating section 132a calculates the light emission brightness value of each light emitting area based on the weighted amount of feature output from weighting section 134. To be more specific, light emission brightness value calculating section 132a, using a conversion table, converts the weighted amount of feature of every image display area into a light emission brightness value of the corresponding light emitting area, and outputs this light emission brightness value to illuminating section 120 and image signal correcting section 140.

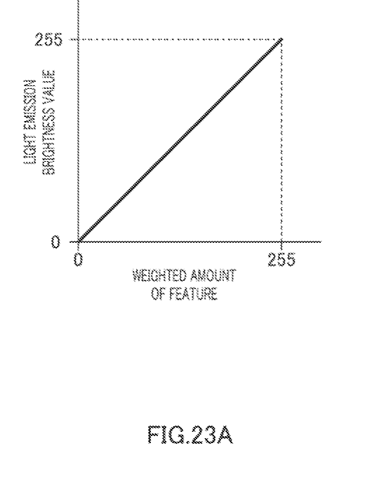

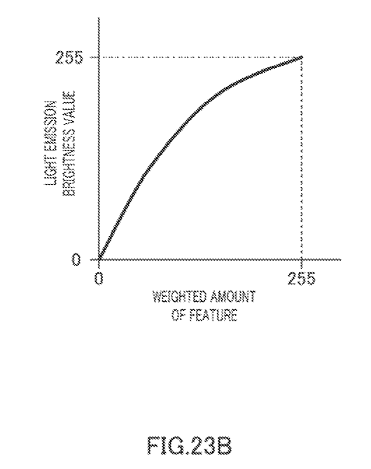

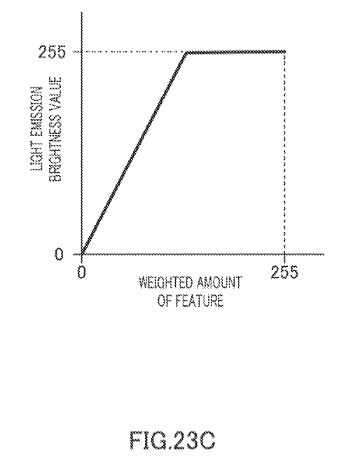

FIG. 23A, FIG. 23B and FIG. 23C show examples of characteristics of conversion tables for conversion of a weighted amount of feature into a light emission brightness value. In FIG. 23A to FIG. 23C, the horizontal axis is the amount of feature and the vertical axis is the reference brightness value. FIG. 23A to FIG. 23C show the same characteristics as the characteristics shown in FIG. 8A to FIG. 8C.

### Embodiment 2

Now, embodiment 2 of the present invention will be described. The liquid crystal display apparatus according to the present embodiment has the same basic configuration as the liquid crystal display apparatus of the previous embodiment. Parts that are the same or equivalent to the ones described with the previous embodiment will be assigned the same reference numerals and differences from the previous embodiment will be primarily explained.

A case will be described with the present embodiment where a weighting area is set on a variable basis in accordance with the complexity of the motion of images.

<2-1. Configuration of Liquid Crystal Display Apparatus>

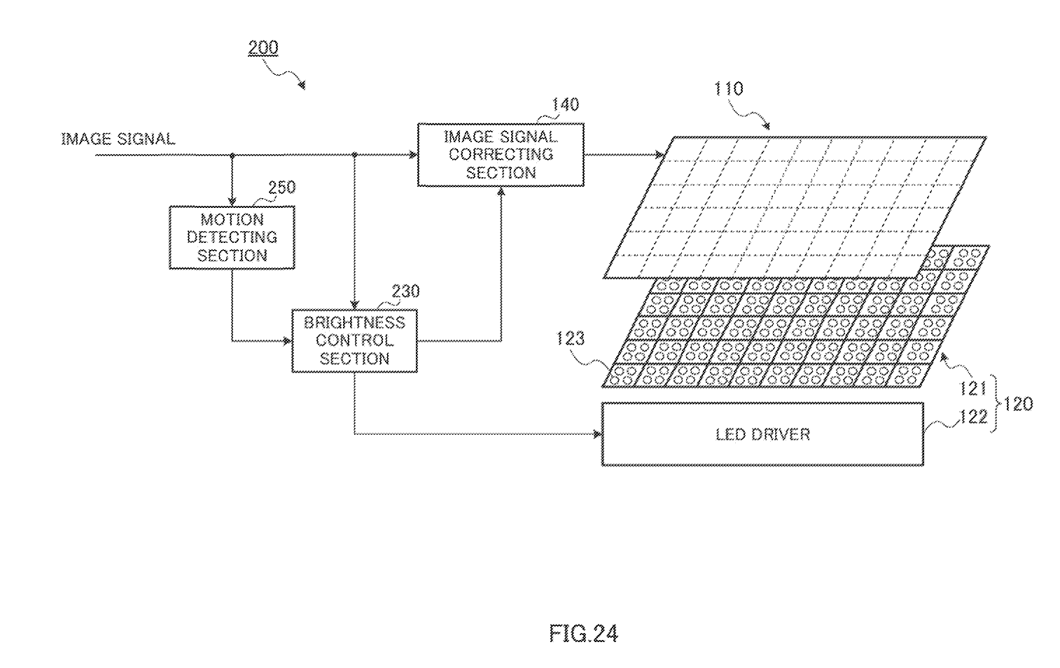

FIG. 24 shows a configuration of a liquid crystal display apparatus according to the present embodiment. Liquid crystal display apparatus 200 has brightness control section 230 and motion detecting section 250 instead of brightness control section 130 and motion detecting section 150. Illuminating section 120, brightness control section 230 and motion detecting section 250, combined, constitute a backlight apparatus.

<2-1-1. Motion Detecting Section>

Motion detecting section 250 is an operation processing apparatus to perform operations for detecting the motion of images—especially the complexity of motion of images—based on image signals. The method of detecting motion is the same as in embodiment 1.

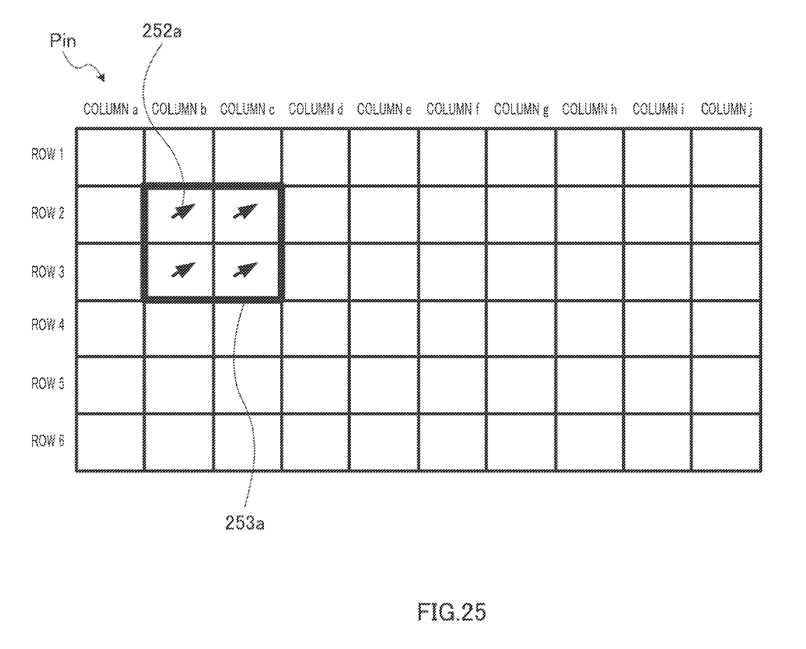

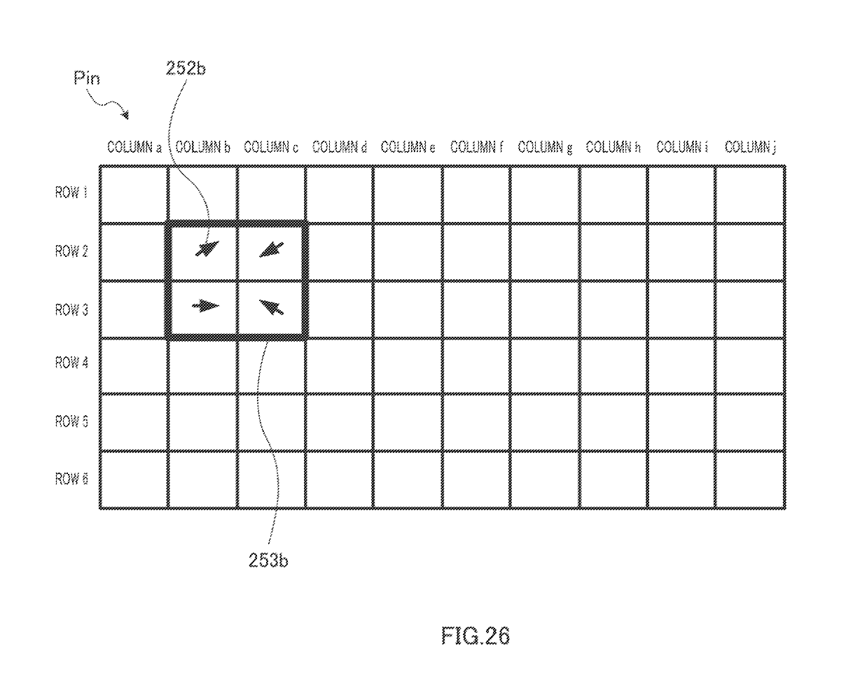

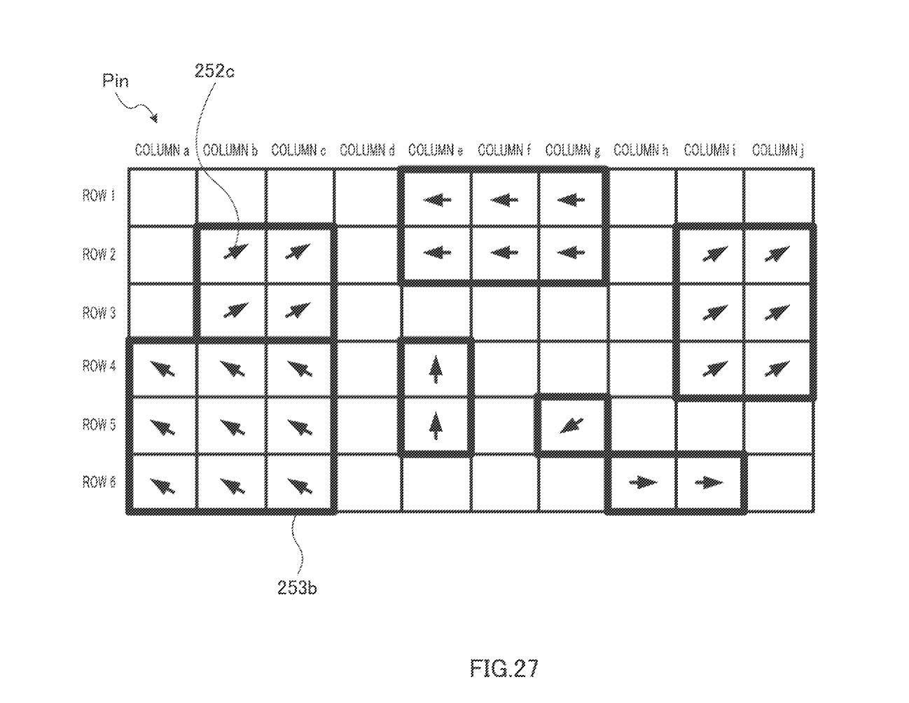

FIG. 25, FIG. 26 and FIG. 27 show examples of motion detection results.

In the example of FIG. 25 in one motion range 253a, calculated motion vectors 252a have the same orientation. In the example of FIG. 26, in the same one motion range 253a as shown in FIG. 25, calculated motion vectors 252b have varying orientations. In the example of FIG. 27, there are many motion ranges 253b, motion vectors 252c have the same orientation in each individual motion range 253b, but the orientations of motion vectors 252c change in different motion ranges 253b.

To compare the example of FIG. 25 and the example of FIG. 26, motion vectors 252b in FIG. 26 are oriented less uniformly than the uniformity of orientation of motion vectors 252a in FIG. 25. That is to say, the motion of image is more complex in the example of FIG. 26 and the example of FIG. 25.

The uniformity of orientation holds when motion vectors show the same single orientation, regardless of the magnitude of motion vectors. Consequently, when one motion vector is calculated, the motion vector naturally shows high uniformity of orientation, whereas, when a plurality of motion vectors are calculated, the uniformity of orientation is high if all the motion vectors have the same orientation. To compare the example of FIG. 25 and the example of FIG. 27, in motion ranges 253a and 253b located in the same position, motion vectors 252a and 252c show the same orientation. However, in the example of FIG. 27, in other motion ranges 253b, there are motion vectors 252c having a different orientation. Consequently, the uniformity of orientation of motion vectors 252c in FIG. 27 is lower than the uniformity of orientation of motion vectors 252a in FIG. 25. That is to say, in the example of FIG. 27, the motion of images is more complex than in the example of FIG. 25.

<2-1-2. Brightness Control Section>

Brightness control section 230 is an operation processing apparatus to perform operations for determining the light emission brightness value of each light emitting area based on image signals.

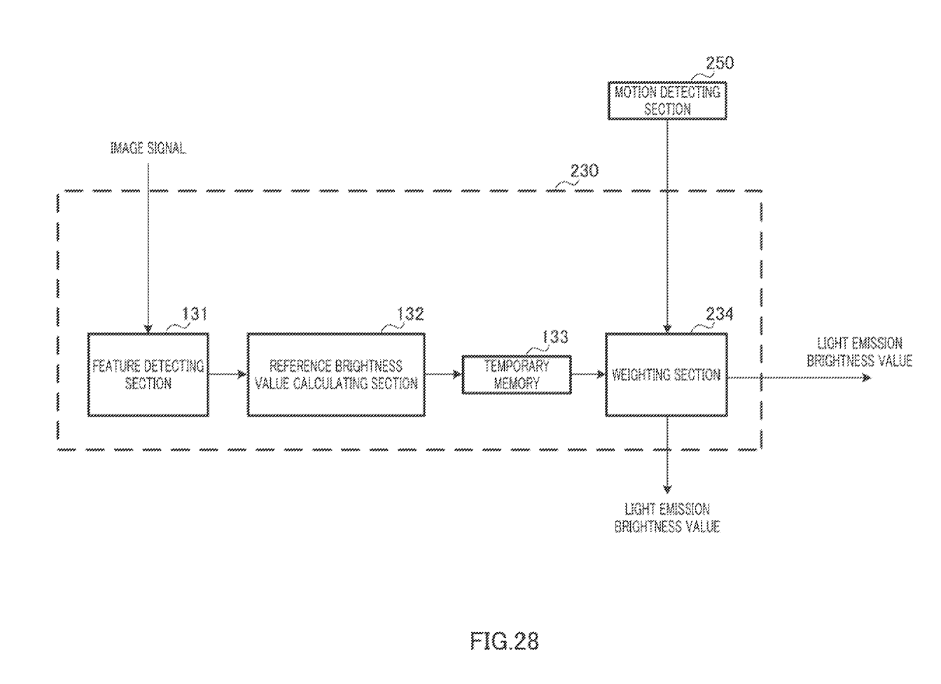

FIG. 28 is a block diagram showing a configuration of brightness control section 230. Brightness control section 230 has weighting section 234 instead of weighting section 134.

Weighting section 234 sets the configuration of a weighting area comprised of the first light emitting area and second light emitting areas on a variable basis in accordance with the complexity of motion detected.

To be more specific, weighting section 234 changes the configuration of a weighting area, by performing setting such that the weighting area is made bigger or smaller depending on the complexity of motion detected—especially by increasing or decreasing the number of second light emitting areas.

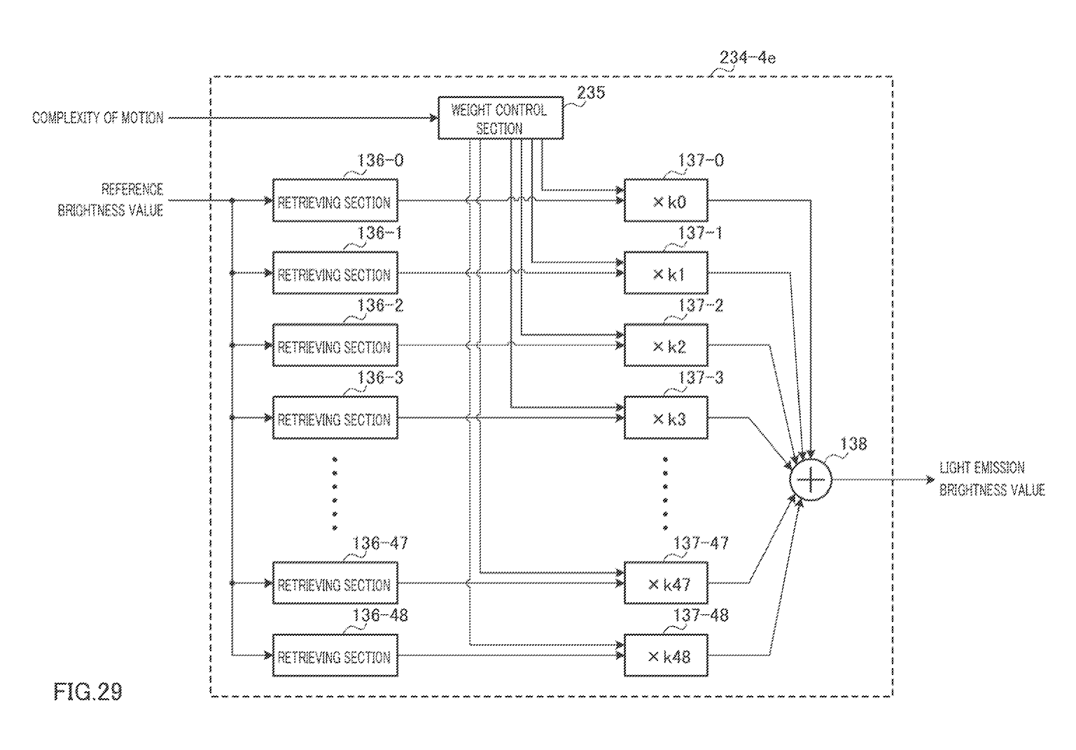

FIG. 29 is a block diagram showing a configuration of weighting section 234. To be more accurate, the configuration of weighting section 234 is a collected body of configurations shown in FIG. 29. Although the configuration of weighting section 234-4e provided in association with light emitting area 4e will be described here, the same configurations as the weighting section 234-4e is provided for each light emitting area.

Weighting section 234-4e has weight control section 235 instead of weight control section 135.

Weight control section 235 controls weights k0 to k48 to use in multiplying sections 137-0 to 137-48. To be more specific, weight control section 135 sets the configuration of a weighting area in accordance with the complexity of motion detected in motion detecting section 250, determines the weights to apply to the reference brightness values calculated with respect to each light emitting area constituting the set weighting area, and outputs weight information to show the determined weights to multiplying sections 137-0 to 137-48.

Weight control section 235 is able to use a weight control method to derive control results shown in FIG. 10A to FIG. 10H, like weight control section 135 of embodiment 1.

If, for example, the complexity of detected motion is high—in other words, if an image shows complex motion—narrow weighting area 160 shown in FIG. 10A to FIG. 10D is set. Also, when the complexity of motion is detected low—in other words, if an image show simple motion—wide weighting area 160 shown in FIG. 10E is set. Also, if the complexity of motion is detected to be about medium, weighting area 160 having the medium width shown in FIG. 10F to FIG. 10H is set.

By this means, weight control section 235 sets the configuration of weighting area 160 on a variable basis by making weighting area 160 bigger or smaller depending on the complexity of motion detected.

As described earlier, a weighting area is set on a variable basis such that a narrower weighting area is set when an image shows more complex motion. The visibility of flicker due to impure black changes significantly due to the speed of motion of an image object and the complexity of motion of an image object. That is to say, flicker is more visible when motion is simple or is less visible when motion is complex. This is because, when looking at a moving object, a human unintentionally predicts the direction of the movement of that moving object, and the object is easier to follow when the motion is simple. Consequently, by setting a weighting area on a variable basis as described above, it is possible to make flicker due to impure black difficult to see.

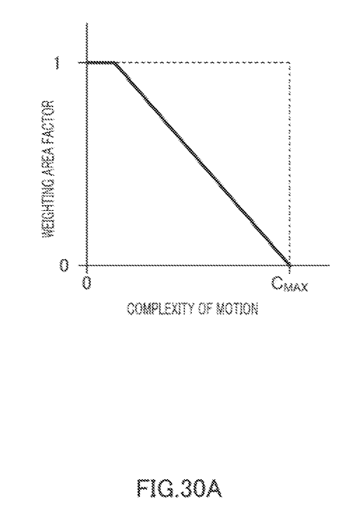

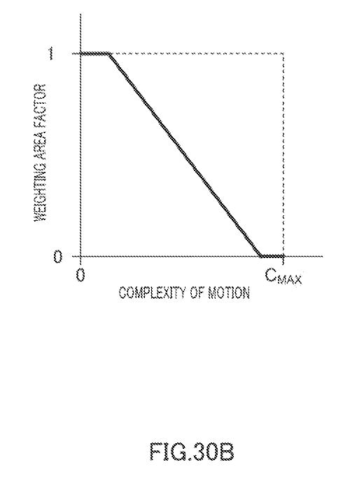

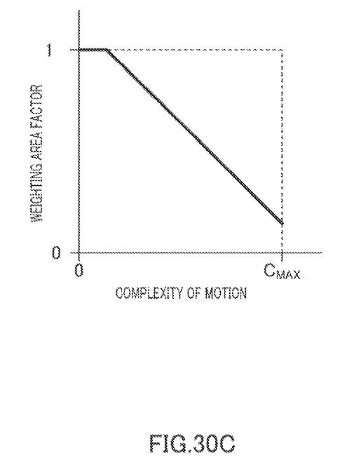

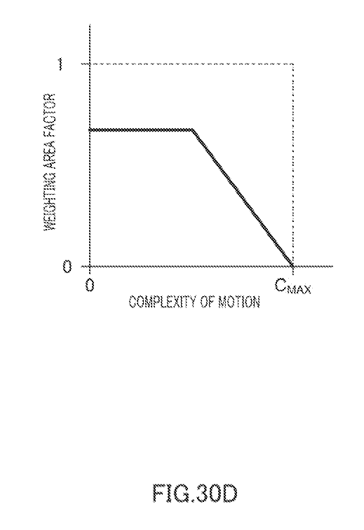

For a weighting area setting method for setting a wider weighting area for faster image motion, various methods are possible, as shown in FIG. 30A to FIG. 30D, for example. In FIG. 30A to FIG. 30D, C_{MAX} is the maximum value of speed of motion that can be detected.

The present embodiment can be combined with the earlier embodiments as appropriate.

### Embodiment 3

Now, embodiment 3 of the present invention will be described below. The liquid crystal display apparatus of the present embodiment has the same basic configuration has the liquid crystal display apparatus of the above embodiment. Parts that are the same or equivalent to the ones described with the previous embodiment will be assigned the same reference numerals and differences from the previous embodiment will be primarily explained.

A case will be described with the present embodiment where a weighting area is set on a variable basis depending on the scale of motion of an image (that is, the size of one motion range).

<3-1. Configuration of Liquid Crystal Display Apparatus>

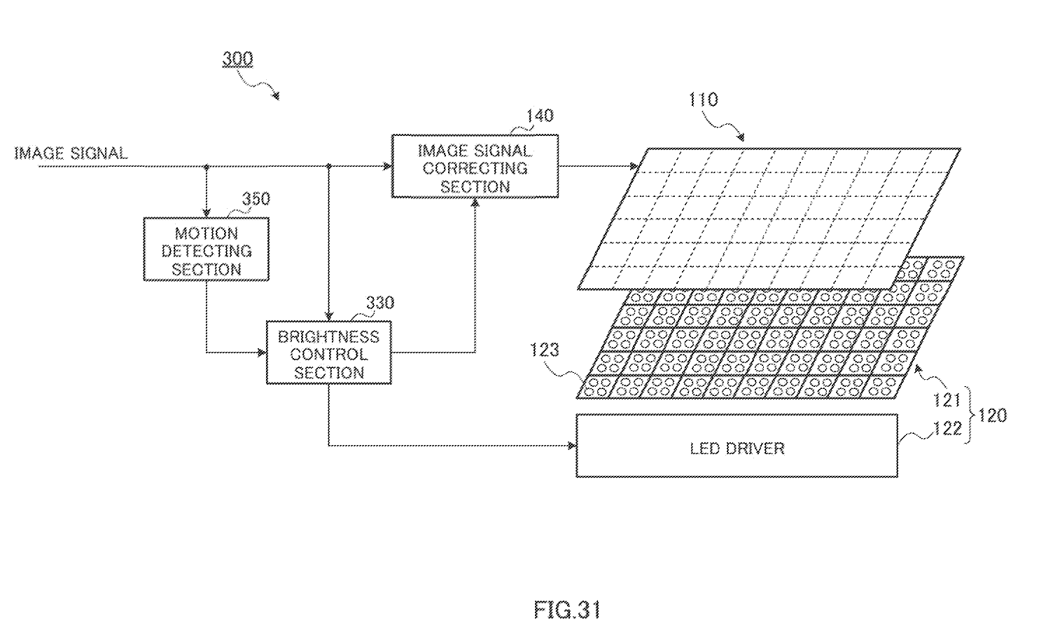

FIG. 31 shows a configuration of the liquid crystal display apparatus according to the present embodiment. Liquid crystal display apparatus 300 has brightness control section 330 and motion detecting section 350 instead of brightness control section 130 and motion detecting section 150. Illuminating section 120, brightness control section 330 and motion detecting section 350, combined, constitute a backlight apparatus.

<3-1-1. Motion Detecting Section>

Motion detecting section 350 is an operation processing apparatus to perform operation for detecting the motion of an image—especially the scale of motion of an image—based on an image signal. The method of detecting motion is the same as in embodiment 1.

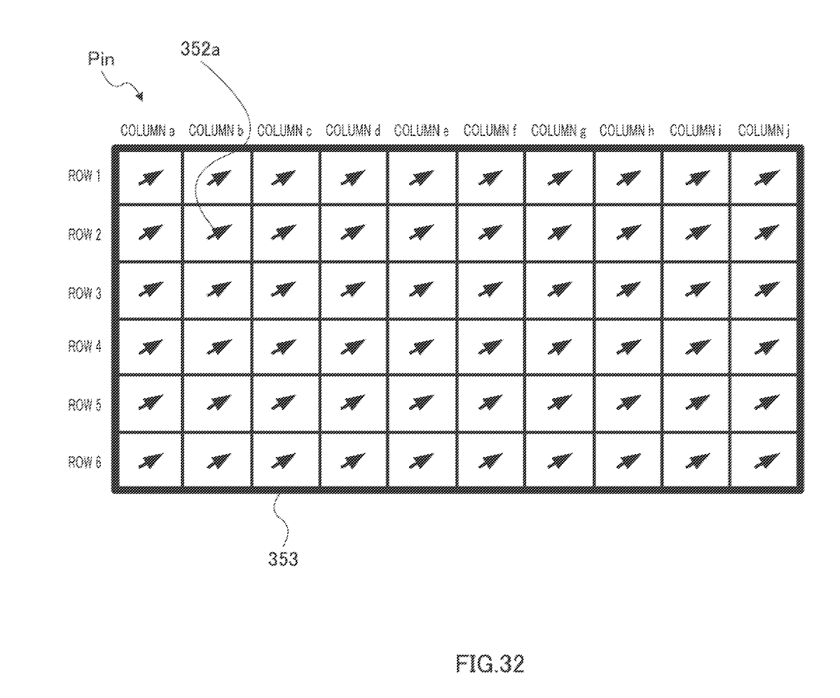

FIG. 32 shows motion detection result.

In the example shown in FIG. 32, in one motion range 353, motion vectors 352a that are calculated are oriented alike, but motion range 353 itself is bigger than motion ranges 153 and 253a shown in FIG. 5 and FIG. 25. In the example of FIG. 32, the scale of motion of the image is bigger than in the examples of FIG. 5 and FIG. 25.

<3-1-2. Brightness Control Section>

Brightness control section 330 is an operation processing apparatus to perform operation for determining the light emission brightness value of each light emitting area based on image signals.

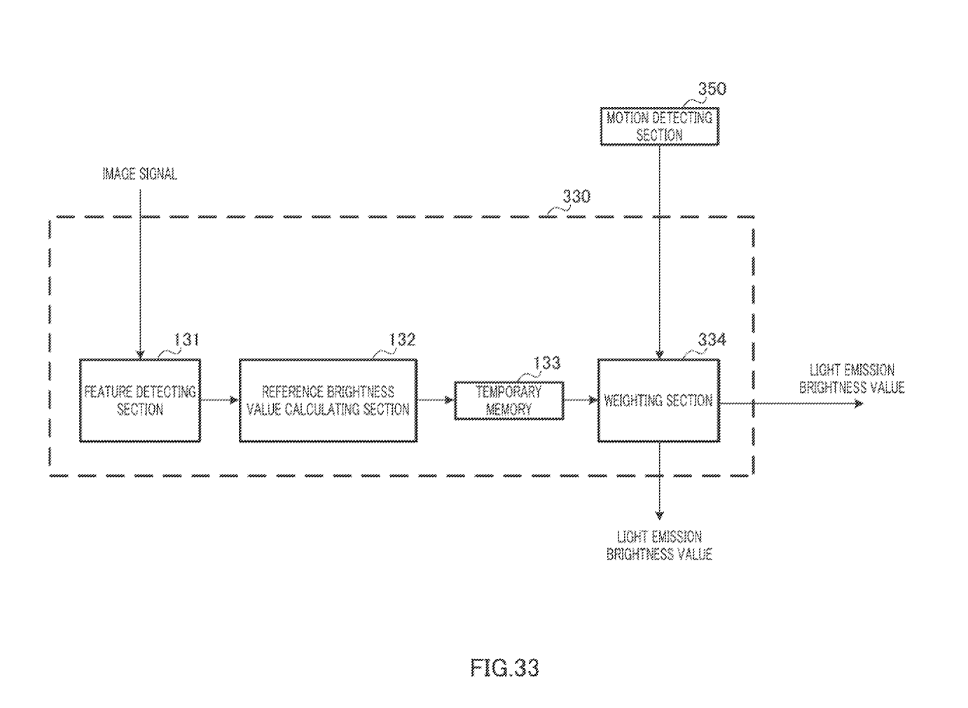

FIG. 33 is a block diagram showing a configuration of brightness control section 330. Brightness control section 330 has weighting section 334 instead of weighting section 134.

Weighting section 334 is able to set the configuration of a weighting area comprised of the first light emitting area and second light emitting areas depending on the scale of motion detected.

To be more specific, weighting section 334 changes the configuration of a weighting area, by performing setting such that the weighting area is made bigger or smaller depending on the scale of motion detected—especially by increasing or decreasing the number of second light emitting areas.

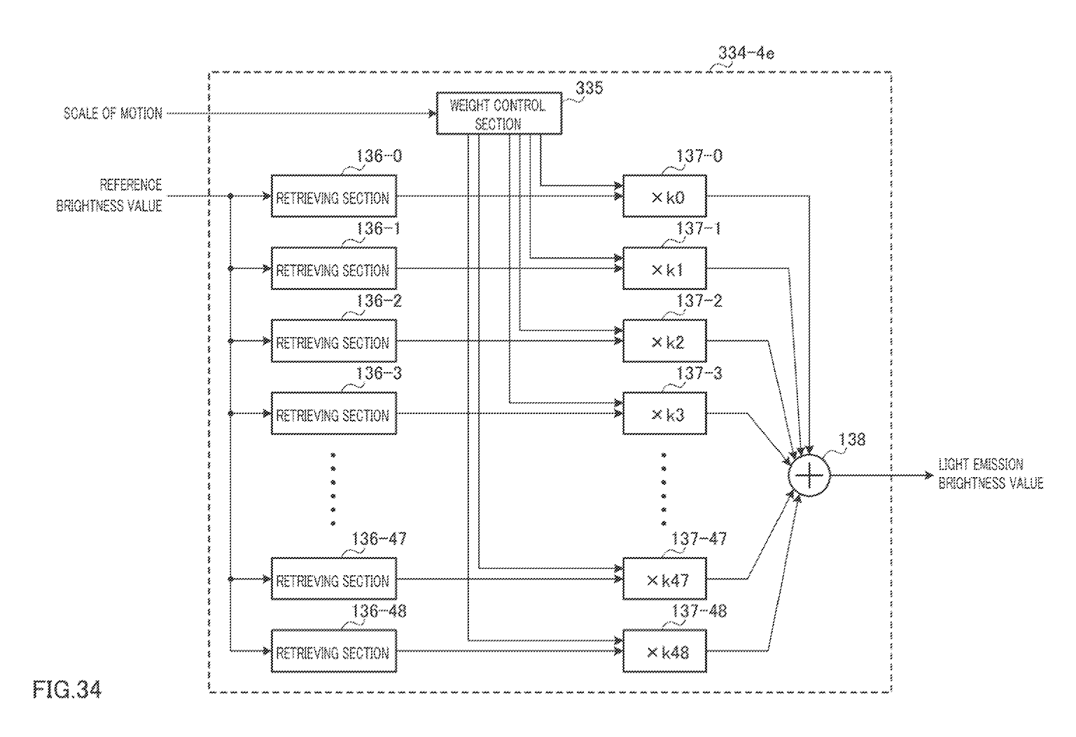

FIG. 34 is a block diagram showing a configuration of weighting section 334. To be more accurate, the configuration of weighting section 334 is a collected body of configurations shown in FIG. 34. Although the configuration of weighting section 334-4e provided in association with light emitting area 4e will be described here, the same configurations as the weighting section 334-4e is provided for each light emitting area.

Weighting section 334-4e has weight control section 335 instead of weight control section 135.

Weight control section 335 controls weights k0 to k48 which multiplying sections 137-0 to 137-48 use. To be more specific, weight control section 335 sets the configuration of a weighting area in accordance with the scale of motion detected in motion detecting section 350, determines the weights to apply to the reference brightness value calculated with respect to each light emitting area constituting the set weighting area, and outputs weight information to show the determined weights, to multiplying sections 137-0 to 137-48.

Weight control section 335 is able to use a weight control method to derive control results shown in FIG. 10A to FIG. 10H, like weight control section 135 of embodiment 1.

If, for example, the detected scale of motion is large—in other words, if a wide motion range is identified—narrow weighting area 160 shown in FIG. 10A to FIG. 10D is set. Also, when the detected scale of motion is small—in other words, if a narrow motion range is identified—wide weighting area 160 shown in FIG. 10E is set. Also, if the scale of motion is detected to be about medium, weighting area 160 having the medium width shown in FIG. 10F to FIG. 10H is set.

By this means, weight control section 335 sets the configuration of weighting area 160 on a variable basis by making weighting area 160 bigger or smaller depending on the scale of motion detected.

As described earlier, a weighting area is set on a variable basis such that a narrower weighting area is set when an image shows bigger scale of motion. The visibility of flicker due to impure black changes depending on the scale of motion of an image object, like the speed and complexity of motion of an image object. That is to say, when the motion of scale is small, the observer's point of view is likely to focus on certain specific points so that the visibility of flicker increases. On the other hand, when the scale of motion is large (e.g. entire-screen scroll display) the visibility of flicker is low. Consequently, it is possible to make flicker due to impure black difficult to see, by setting a weighting area on a variable basis as described above.

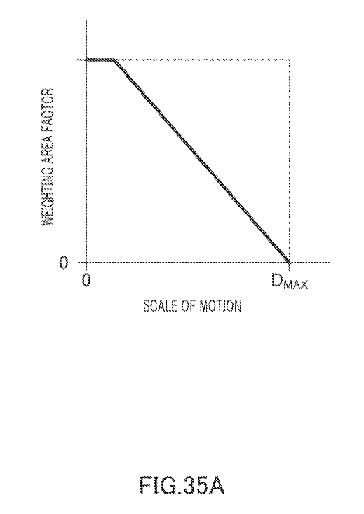

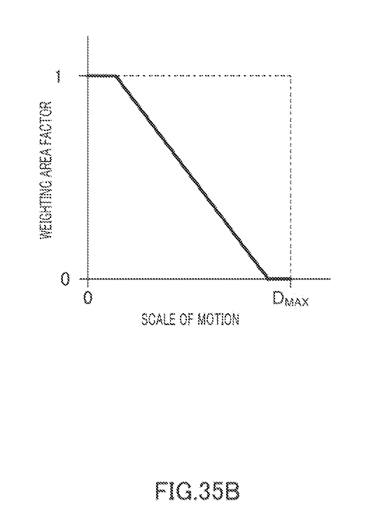

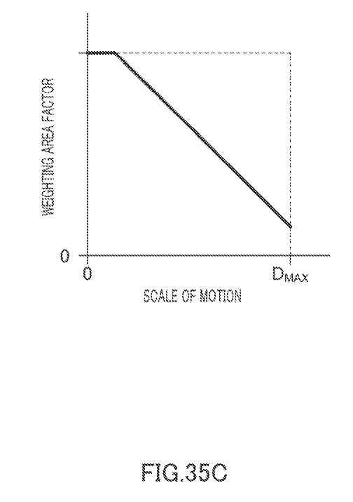

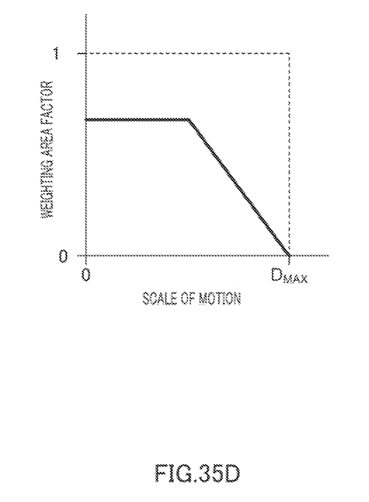

For a weighting area setting method for setting a narrower weighting area for a larger scale of motion of an image, various methods are possible, as shown in FIG. 35A to FIG. 35D, for example. In FIG. 35A to FIG. 35D, D_{MAX} is the maximum value of speed of motion that can be detected.

The present embodiment may be combined with earlier embodiments as appropriate.

For example, it is possible to evaluate “complexity of motion” in a broader sense, by evaluating “motion scale” which is used in the present embodiment as a motion parameter to relate to the motion of an image, and “uniformity of orientation” which is used in embodiment 2 as a motion parameter of “complexity of motion,” in a complex fashion.

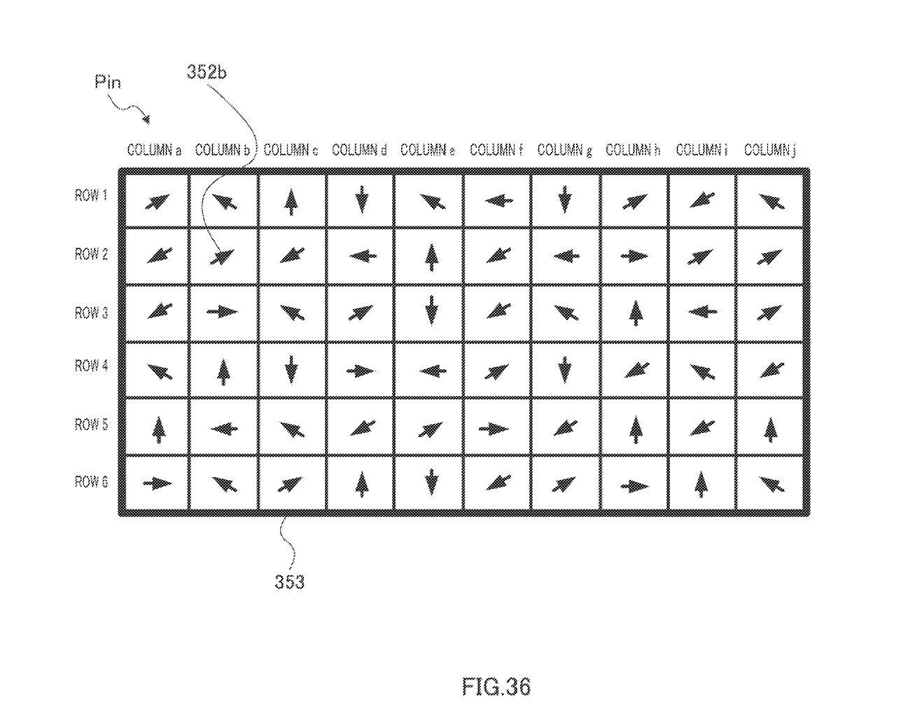

For example, in the motion detection result shown in FIG. 36, motion range 353 is wide and motion vectors 352b in motion range 353 are turned in various directions. In this case, in the example of FIG. 36, the motion of image may be evaluated to be complex compared to the example shown in FIG. 26 or the example of FIG. 32.

Embodiments of the present invention have been described. The above descriptions only show preferred embodiments of the present invention by way of example, and the scope of the present invention is by no means limited to these. That is to say, the configurations and operations of the apparatuses explained with the above embodiments are simply examples, and, obviously, various changes, additions and omissions can be made in part without departing from the spirit of the present invention.

For example, although cases have been described with the above embodiments where the configuration of the width of a weighting area is set on a variable basis in accordance with motion, it is equally possible to adopt a configuration in which the configuration of weighting in weighting area is changed without changing the width of the weighting area. For example, with embodiment 1, the setting of weighting area 160 shown in FIG. 10A and FIG. 10B is set on a variable basis in accordance with motion. To be more specific, narrow weighting area 160 that is shown in FIG. 10A is set when the detected speed of motion is low—in other words, when the motion of an image shows low speed (slow). By contrast with this, wide weighting area 160 shown in FIG. 10B is set when the detected speed of motion is high—in other words, when the motion of an image shows high speed (fast). With this configuration, it is equally possible to reduce the visibility of flicker in accordance with motion.

Also, although a configuration for weighting is provided in accordance with each light emitting area with the above embodiments, this is by no means limiting. For example, embodiment 1 may be configured to have one of the configuration shown in FIG. 9 to sequentially switch on a per light emitting area basis and sequentially calculate weighted brightness values.

For example, cases have been described with the above embodiments where the present invention is applied to a liquid crystal display apparatus. However, even if the optical modulation section ha a different display section from a liquid crystal display panel, other configurations may be used as long as a non-self luminous configuration is provided. That is to say, the present invention is applicable to non-self luminous display apparatuses other than liquid crystal display apparatuses.

The disclosure of Japanese Patent Application No. 2009-228472, filed on Sep. 30, 2009, including the specification, drawings and abstract, is incorporated herein by reference in its entirety.

### INDUSTRIAL APPLICABILITY

The backlight apparatus and display apparatus of the present invention provide advantages of reducing impure black upon movie display and reducing the visibility of flicker, and are use as a backlight apparatus and display apparatus to control lighting of a plurality of display areas individually.

### REFERENCE SIGNS LIST

100, 200, 300 Liquid crystal display apparatus
110 Liquid crystal panel
120 Illuminating section
121 Light emitting section
122 LED driver
123 LED
130, 230, 330 Brightness control section
140 Image signal correcting section
150, 250, 350 Motion detecting section
131 Feature detecting section
132 Reference brightness value calculating section
132a Light emission brightness value calculating section
133 Temporary memory
134, 234, 334 Weighting section
135, 235, 335 Weight control section
136 Retrieving section
137 Multiplying section
138 Adding section

1. A backlight apparatus comprising:
a light emitting section that has a plurality of light emitting areas which emit illumination light individually, and that illuminates an optical modulation section by the illumination light from the plurality of light emitting areas;
a motion detecting section that detects motion of an image from an image signal;
a brightness control section that acquires a brightness determination reference value for each light emitting area based on the image signal, applies weights to brightness determination reference values acquired with respect to one or more light emitting areas constituting the weighting area, and determines light emission brightness values on a per light emitting area basis based on results of the weighting; and
a drive section that drives each of the plurality of light emitting areas according to the light emission brightness values determined on a per light emitting area basis, wherein the brightness control section sets the light emitting areas to constitute the weighting area in accordance with detected motion.

2. The backlight apparatus according to claim 1, wherein the brightness control section sets the light emitting areas to constitute the weighting area by making the weighting area bigger or smaller.

3. The backlight apparatus according to claim 2, wherein:
the motion detecting section detects speed of motion of an image as motion of the image; and
the brightness control section sets the weighting area wider with respect to faster motion.

4. The backlight apparatus according to claim 2, wherein:
the motion detecting section detects complexity of motion of an image as motion of the image; and
the brightness control section sets the weighting area narrower with respect to more complex motion.

5. The backlight apparatus according to claim 2, wherein:
the motion detecting section detects scale of motion of an image as motion of the image; and
the brightness control section sets the weighting area narrower with respect to motion of bigger scale.

6. A display apparatus comprising the back light apparatus and optical modulation section of claim 1.
